(19) United States
(12) Patent Application Publication
(10) Pub. No.: US 2012/0191469 A1
(43) Pub. Date: Jul. 26, 2012

(54) SYSTEM AND PROCESS FOR EVALUATING AND PROMOTING HEALTH, WELLNESS, AND FITNESS IN INDIVIDUALS

(75) Inventor: Bahram Akradi, Minnetrista, MN (US)

(73) Assignee: LIFE TIME FITNESS, INC., Chanhassen, MN (US)

(21) Appl. No.: 13/356,081

(22) Filed: Jan. 23, 2012

Related U.S. Application Data
(60) Provisional application No. 61/435,141, filed on Jan. 21, 2011.

(51) Int. Cl. G06Q 50/22

(52) U.S. Cl. 705/2

(57) ABSTRACT

Systems and processes for evaluating and promoting health, wellness, and fitness in individuals and for customizing and promoting training program for such individuals are disclosed. A system for evaluating the health, wellness, and fitness status of individuals eligible for participation within an employer sponsored health plan comprises a health club network, a physicians network, and a laboratory network. Health-related data and laboratory results acquired from each individual are reviewed by qualified medical personnel in order to determine their eligibility for participation in a plan. A health analysis module is configured for generating a health, wellness, and fitness profile and health score for individuals that choose to participate in the plan.

### CROSS-REFERENCE TO RELATED APPLICATION

This application claims priority to Provisional Application No. 61/435,141, filed Jan. 21, 2011, entitled “Individuated Health, Wellness, and Fitness Training System,” the contents of which are incorporated herein by reference in their entirety for all purposes.

### TECHNICAL FIELD

The present disclosure relates generally to evaluating and promoting health, wellness, and fitness in individuals. More specifically, the present disclosure relates to systems and processes for analyzing the health, wellness, and fitness status of individuals eligible for participation within an employer sponsored health plan, and for customizing and promoting health and fitness training programs for such individuals.

### BACKGROUND

Comprehensive health and wellness management is a growing concern in the health and fitness industry as healthcare costs continue to rise. This concern is particularly prevalent for employers that provide healthcare insurance plans for certain employees who, through lack of exercise and certain lifestyle choices, can lead to significant expenses for the employer. Indirect costs associated with unhealthy employees can also result in a loss in worker productivity due to sickness or illness. In many instances, these healthcare costs can be greatly reduced when the employee is enrolled in an incentivized health and fitness program that provides the employee with a reduction in membership fees or other benefit for attending a health club on a regular basis. Such programs have been shown to result in a significant drop in healthcare related costs for employers along with an increase in worker productivity. For example, the occurrence of heart attack related deaths and other chronic conditions can be significantly reduced or prevented altogether with regular exercise and healthy lifestyle and nutritional choices, resulting in a reduction in healthcare related costs and an increase in worker productivity.

The data used to evaluate the health and wellness of individuals and to assess an individual's exercise needs is often based on self-reporting through the use of health risk assessment questionnaires or “par-Q” assessments. Typically, individuals that participate in health and fitness programs do not undergo a comprehensive physical evaluation in order to determine their suitability for participation within the program. Moreover, while long-term medical data for the individual may exist, such data is typically confidential or is not available for use by health clubs to assess the individual's ability to enroll in a particular health or fitness training program, nutrition planning, or to determine their suitability to engage in rigorous exercise. As a result, it is often difficult for health clubs to gain a complete and comprehensive understanding of the individual's health and fitness needs.

There are numerous programs for promoting health and wellness for individuals that exercise on a regular basis. Such programs, however, are typically focused on improving only one aspect of the individual's health, and do not provide a comprehensive solution that takes into account factors such as the individual's lifestyle and nutritional choices in developing a training program. In some cases, such programs do not provide a comprehensive solution that addresses the underlying health problem. For example, many existing programs rely upon self-reported health risk assessment data, which is often incorrect or incomplete. As a result, the health and wellness needs of many individuals are often not adequately assessed, which can lead to the development of a fitness program that is inappropriate for the individual. Further, many of the programs leave individuals with numerous data points that can be confusing for participants to understand, instead of providing them with one score that measures their overall health and wellness based on risk levels for multiple, key indicators. Moreover, the incentives provided by health and wellness programs are typically based on only the individual's attendance at a health club, completion of a health questionnaire or simply participating in an assessment, and not on the individual's actual achievement of goals related to their fitness program.

### SUMMARY

The present disclosure relates to systems and processes for analyzing the health, wellness, and fitness status of individuals eligible for participation within a health benefits or insurance program, and for customizing and promoting health and fitness training programs for such individuals.

An example system for evaluating the health, wellness, and fitness status of individuals eligible for participation within a health plan offered by an employer comprises a health club network including at least one scheduling and data input station and at least one screening station; a laboratory network configured for performing laboratory tests on lab samples acquired from the at least one screening station; a physicians network comprising a network of medical personnel for analyzing health-related data acquired by the health club network and laboratory data acquired from laboratory tests performed by the laboratory network; a computer database configured for storing the health-related data and laboratory data; and a means for evaluating each individual's eligibility to enroll in the plan. In some embodiments, the system provides the individual with a comprehensive yet concise health score based on the individual's risk levels for several key health indicators.

An example process for evaluating the health, wellness, and fitness status of an individual eligible for participation within a health plan offered by an employer comprises obtaining an eligibility file containing a list of individuals eligible for participation within the plan; prompting an individual to create an on-line account and complete a health risk assessment questionnaire; scheduling at least one screening session at a screening station for evaluating health-related data for the individual; collecting at least one laboratory sample from the individual during the at least one screening session; prompting a laboratory test be conducted on the laboratory sample; prompting medical personnel to review laboratory results obtained from the laboratory test and the health-related data obtained from the individual; generating a health, wellness, and fitness profile and health score for the individual based at least in part on the laboratory results and the health-related data; and storing the profile and health score in a computer database.

An example process for approving an individual for participation within a health plan offered by an employer comprises linking a health club network to a physicians network and a laboratory network, the health club network including at least one screening station configured for acquiring health-related data and laboratory samples from an individual; transmitting an order request to the physicians network prompting medical personnel within the physicians network to review the health-related data acquired by the screening station; prompting the physicians network to transmit a laboratory order request to the laboratory network for performing one or more laboratory tests on the laboratory samples acquired from the screening station; prompting the medical personnel to review laboratory results obtained from the one or more laboratory tests and the health-related data; determining whether the individual is eligible for enrollment in the plan; and storing the laboratory results and health-related data in a computer database.

### BRIEF DESCRIPTION OF THE DRAWINGS

FIG. 1 is a schematic view showing an illustrative system for evaluating the health, wellness, and fitness status of individuals eligible for participation within an employer sponsored health plan;

FIG. 2 is a schematic view showing an example health club network that can be used in conjunction with the system of FIG. 1 for gathering data and analyzing an individual's health, wellness, and fitness status;

FIG. 3 is a schematic view showing an example process for gathering data and analyzing an individual's health, wellness, and fitness status using the system of FIG. 1;

FIG. 4 is a schematic view showing an example approval process for approving individuals eligible for participation in an employer sponsored health plan using the system of FIG. 1;

FIG. 5 is a schematic view showing an example of a health, wellness, and fitness profile generated by the health analysis module of FIG. 2;

FIG. 6 is a schematic view showing an example process for generating a health score using the health analysis module of FIG. 2;

FIGS. 7A-7B is a flow diagram showing an example implementation of the process of FIG. 6 for determining an individual's health score;

FIGS. 8A-8B are several views showing an example graphical user interface configured for displaying a health, wellness, and fitness profile and health score for an individual;

FIG. 9 is a schematic view showing a system for customizing a health, wellness, and fitness training program in accordance with an illustrative embodiment;

FIG. 10 is a flow diagram showing an illustrative method for promoting health and wellness in participants using the system of FIG. 9;

FIGS. 11A-11B is a flow diagram showing an example process for generating a customized a health, wellness, and fitness program using the system of FIG. 9;

FIG. 12 is a schematic view showing several example lifestyle-related parameters and associated goals that can be analyzed by a health and wellness coach using the system of FIG. 9;

FIG. 13 is a schematic view showing several example health-related parameters and associated goals that can be analyzed by a health and wellness coach using the system of FIG. 9;

FIG. 14 is a schematic view showing an example health, wellness, and fitness training program that can be generated for a participant;

FIG. 15 is a view showing an example dashboard screen that can be used for displaying a list of action plan items and associated goals;

FIG. 16 is a view showing an example dashboard screen that can be used for displaying action plan items for a customized health, wellness, and fitness training program; and

FIG. 17 is a view showing an example dashboard screen that can be used for displaying lifestyle and health-related information gathered from a participant.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

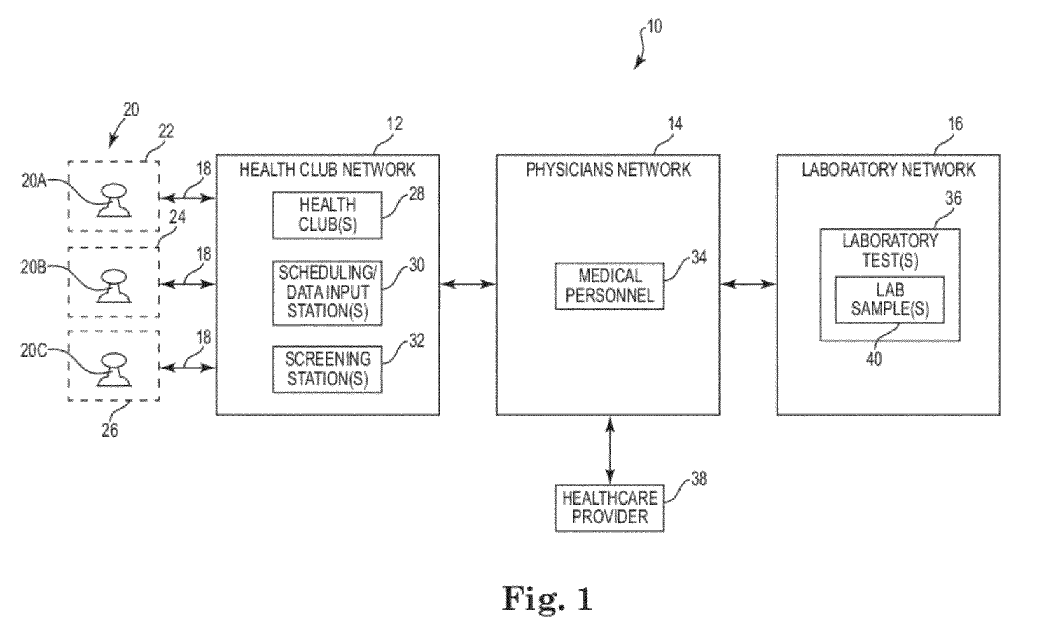

FIG. 1 is a schematic view showing an illustrative system 10 for evaluating the health, wellness, and fitness status of individuals eligible for participation within an employer sponsored health plan. As shown in FIG. 1, the system 10 includes a health club network 12, a physicians network 14, and a laboratory network 16, which together are used for analyzing health-related data 18 received from individuals 20a, 20b, 20c eligible for enrollment within one or health plans 22, 24, 26 offered by an employer. In some embodiments, for example, the networks 12, 14, 16 each comprise individual locations or facilities that are linked together to each other via the Internet or an intranet connection. In some embodiments, the networks 12, 14, 16 comprise both physical locations as well as computer infrastructure that can be used for performing tasks independent of the other networks 12, 14, 16. As discussed further herein, individuals 20a, 20b, 20c within each plan 22, 24, 26 may utilize the system 10 to answer health, wellness, and fitness-related questions and to schedule health screenings in order to assess the individual's overall health and ability to engage in a particular program offered by a health club 28.

The eligibility criteria for engaging in a particular plan 22, 24, 26 may vary depending on the specific requirements of each individual's 20a, 20b, 20c program 22, 24, 26. For example, an individual member 20a of a first employer sponsored health plan 22 may be required to answer a list of questions and/or perform screening examinations that are different than an individual member 20b of another plan 24. The system 10 is thus able to tailor the types of health-related data that is gathered and analyzed based on the specific needs and requirements of each plan 22, 24, 26. If, for example, a particular employer 22 requires its members to screen for tobacco usage as a condition for enrollment in a preferred health benefits or insurance plan, the system 10 may customize the questionnaires and health-related screenings in order to ascertain whether an individual 20a is a tobacco user. The plan 22 may then use this data along with other information acquired by the system 10 to determine whether the individual 20a is eligible for the plan and/or is eligible to receive an insurance discount or preferred health insurance rate.

The health club network 12 comprises both physical and computer infrastructure for use in gathering data related to individuals 20a, 20b, 20c within each plan 22, 24, 26. In some embodiments, for example, the health club network 12 includes one or more scheduling and data input stations 30 for scheduling individuals 20a, 20b, 20c to complete questionnaires and to schedule health screenings at one or more screening stations 32.

The physicians network 14 comprises a network of physicians, nurse practitioners, and/or other qualified medical personnel 34 for analyzing data inputted to and received by the health club network 12 as well as any laboratory results received back from laboratory tests 36 performed by the laboratory network 16. In certain embodiments, the physicians network 14 comprises a network of physicians approved by the health club 28 and/or by the individuals' health plan 22, 24, 26. In some embodiments, for example, the physicians network 14 includes one or more medical clinics authorized by the health club 28 and/or by a health insurance provider to participate in the system 10. The physicians network 14 also includes communications infrastructure for communicating data back and forth between the health club network 12 and the laboratory network 16, and for scheduling laboratory tests 36 to be performed by the laboratory network 16. In some embodiments, the physicians network 14 is also configured to receive and analyze data directly from an individual's provider

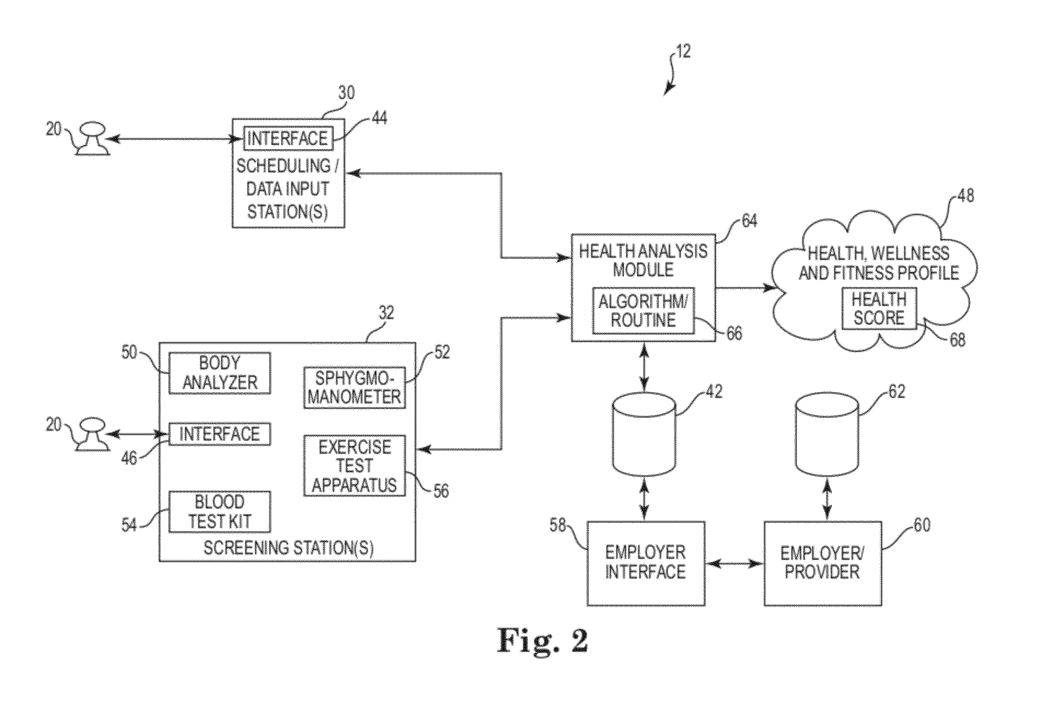

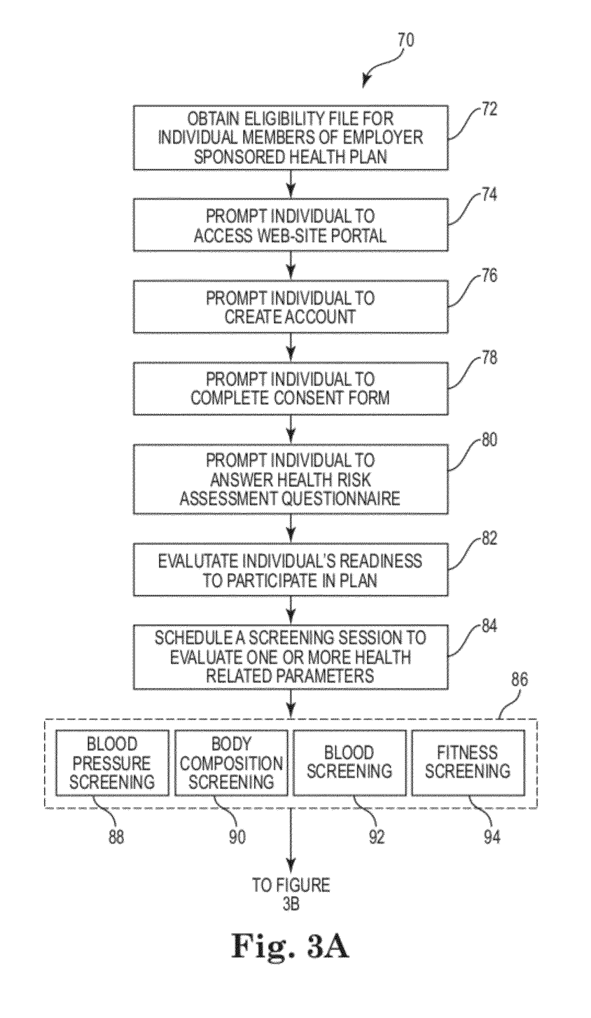

The laboratory network 16 comprises physical and computer infrastructure used for performing laboratory tests 36 of lab samples 40 obtained by the health club screening stations 32, and for communicating the results of such tests 36 to the physicians network 14 for further analysis. In some embodiments, for example, the laboratory network 16 includes laboratory equipment and personnel for analyzing blood and urine samples ordered by medical personnel 34 from the physicians network 14. In the embodiment of FIG. 2, the laboratory network 16 comprises a separate network from the health club network 12 and physicians network 14. In other embodiments, the laboratory network 16 and physicians network 14 are integrated together into a single network that communicates with the health club network 12.

The type of laboratory tests 36 that are performed and/or the type of laboratory samples 40 that are taken may differ depending on the eligibility criteria of the individual's health plan 22, 24, 26, and/or based on the individual's particular health, wellness, and fitness status. If, for example, an employer requires tobacco and cholesterol screening as a condition for enrollment in a preferred health plan, the types of laboratory tests 36 that are performed may vary from an employer that does not require tobacco or cholesterol screening as a condition for enrollment in one of their plans.

FIG. 2 is a schematic view showing an example health club network 12 that can be used in conjunction with the system 10 of FIG. 1 for gathering data and analyzing an individual's health, wellness, and fitness status. As shown in FIG. 2, the health club network 12 includes one or more scheduling/data input stations 30 and one or more screening stations 32. The stations 30, 32 can comprise, for example, one or more physical and/or virtual locations that can be accessed by individuals 20 in person and/or over a computer network for gathering and inputting data to a database 42 such as a hard-drive, optical drive, memory-unit, or other suitable storage means. In certain embodiments, for example, one or more of the stations 30, 32 comprise a separate customer service area located within a health club that can be used to gather information relating to the health, lifestyle, and goals of individuals 20 that use the health club. One or more of the stations 30, 32 can also include a computer interface 44, 46 to permit an individual 20 or authorized personnel (e.g., a personal trainer, technician, or health and wellness coach) to log-in and supply the database 42 with information relating to the individual's health, lifestyle, and goals.

Although several distinct stations 30, 32 are shown in FIG. 2, in other embodiments one or more of the stations 30, 32 can be grouped together or can be further separated into additional subgroups. Moreover, some of the stations 30, 32 can comprise physical locations (e.g., at a health club or remote site) whereas other stations 30, 32 can comprise virtual stations that are accessible on-line via a network connection. For example, in some embodiments one of the scheduling/data input stations 30 comprises an Internet or intranet portal that can be accessed via a computer interface 44 whereas one of the screening stations 32 comprises a physical location at the health club or an off-site location equipped with testing equipment for performing health screenings on individuals 20.

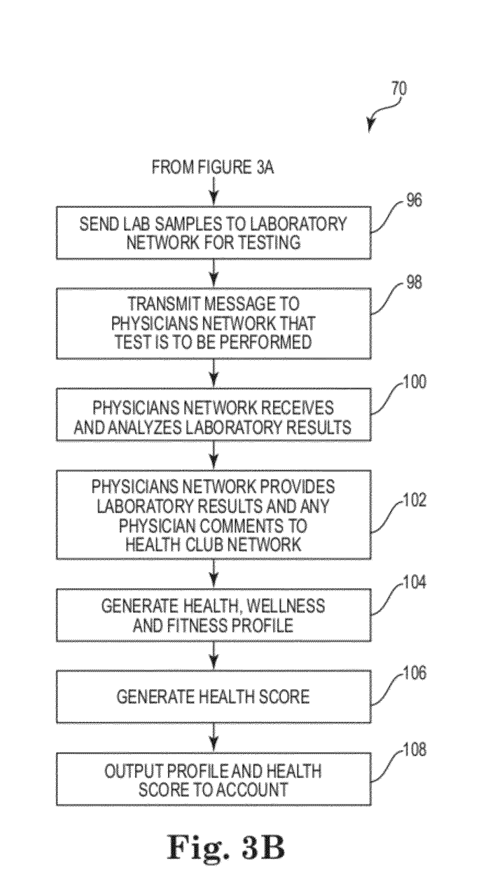

The interface 44 for the scheduling/data input station 30 is configured to gather information from individuals 20 and schedule health-related screenings to be performed at one or more of the screening stations 32. In some embodiments, for example, the interface 44 comprises a computer terminal that can be used to access an on-line scheduling program maintained by the health club for scheduling an in-person screening with a technician at one of the screening stations 32. The interface 44 can also be configured to prompt the individual 20 to enter information into the database 42 prior to scheduling a screening session. In certain embodiments, for example, the scheduling/data input station 30 may prompt the individual 20 to log-in to an Internet or intranet site and complete a comprehensive health risk assessment questionnaire. Example information that can be obtained via the questionnaire can include, but are not limited to, demographic or personal information such as the individual's name, address, telephone number, e-mail address, date of birth, gender, emergency contact information, membership number, and health insurance plan number. Information pertaining to the individual's lifestyle can also be gathered via the scheduling/data input station 30 including, but not limited to, the individual's diet, the types of vitamins or supplements taken, the regularity of smoking and alcohol consumption, the individual's life-stress level, and the individual's physical activity level. An example process for gathering data and analyzing an individual's health, wellness, and fitness status is described further herein with respect to FIG. 3.

The screening stations 32 are used for performing health screenings that can be used in conjunction with information acquired via the questionnaire for generating a comprehensive health, wellness and fitness profile 48 of the individual 20. In some embodiments, the screening station 32 comprises a dedicated area or location within a health club that can be used for performing health screenings on individuals 20. The screening station 30 can also comprise one or more remote stations located off-site from the health club. For example, the screening station 32 can comprise a dedicated site at the individual's corporation, a mobile unit, a health clinic, or other remote location where individuals 20 can be privately screened by a physician, nurse, metabolic specialist, or other authorized individual. In certain embodiments, multiple screening stations 32 may be used to screen each individual 20. For example, the screening station 32 can include a blood screening station for taking a fingerstick or lipid profile of the individual and a body composition/blood pressure screening station for analyzing the individual's body composition and blood pressure.

Each screening station 32 can be used to gather various types of health-related data which, in combination with the demographic, lifestyle, and goal information, can be used to create a comprehensive health, wellness, and fitness profile 48 for the individual 20. In some embodiments, for example, the screening station 32 can include a body analyzer 50 that can be used to gather height, weight, and body composition data from each individual 20. In certain embodiments, the body composition data from the individual 20 can be gathered from a body composition analyzer such as the InBody 520® analyzer available from Biospace of Los Angeles, Calif., which analyzes various parameters relating to the individual's weight, body mass, body water balance, percent body fat, as well as other factors. Other means for analyzing body composition can also be employed. The data received from the individual 20 via each screening station 32 as well as other information supplied by the individual 20 and/or by other health club personnel (e.g., a health and wellness coach) can be used to generate the profile 48.

The screening station 32 can further include a sphygmomanometer 52 to take blood pressure measurements for each individual 20. In some embodiments, a blood test kit 54 can be used to take a small blood sample from each individual 20 for analyzing the individual's blood composition. Example blood parameters that can be measured include, but are not limited to, LDL/HDL levels, total cholesterol, triglyceride level, and glucose level.

The screening station 32 can further include an exercise test apparatus 56 for gathering cardiac and metabolic data for determining the individual's anaerobic threshold during exercise as well as to determine how the individual's body utilizes fuel and how many calories are burned at specific heart rates. In some embodiments, for example, the apparatus 56 can include a respiration mask that analyzes the individual's respiration while the individual 20 performs an exercise routine such as riding on an exercise bike or running on a treadmill. In one embodiment, the exercise test apparatus 56 comprises a metabolic training system such as the ACTIVE METALBOLIC TRAINING SYSTEM^{SM} available from New Leaf, Inc. of St. Paul, Minn. This information can be used in conjunction with the other information gathered from the individual 20 to determine the individual's equivalent body age, aerobic capacity (VO2 max), as well as other parameters.

In some embodiments, an employer interface 58 can be used to transmit data back and forth between the database 42 and a separate database 62 maintained by an employer or an employer's health insurance provider 60. In certain embodiments, for example, the employer interface 58 can be used to transmit historical medical data to the database 42. Information acquired from each individual 20 can also be fed to the database 62 for later use by the employer or employer's health insurance provider 60. In some embodiments, for example, the interface 58 may permit an employer monitor an individual's eligibility, or continued eligibility, to enroll in a preferred health plan offered by the employer 60, and/or to evaluate the individual's ability to engage in certain exercise programs offered by the health club.

Data acquired from the questionnaire, data acquired via the screening stations 32, laboratory test results obtained from the laboratory network 16, and data made available by the individuals' employer/provider 60 are inputted to a health analysis module 64 configured to run a computer algorithm or routine 66 for automatically generating a comprehensive health, wellness, and fitness profile 48 for each individual 20. Additional information generated by medical personnel 34 from the physicians network 14 can also inputted to the analysis module 64 for generating the health, wellness, and fitness profile 48. In certain embodiments, for example, a physician may make an initial assessment as to a particular health condition for the individual 20 (e.g., hypertension), which can then be inputted to the analysis module 64 to aid in generating the profile 48 for that individual 20. In some embodiments, the health analysis module 64 comprises software, and the algorithm or routine 66 is executable as computer readable instructions on a server, desktop computer, laptop computer, or other computing device.

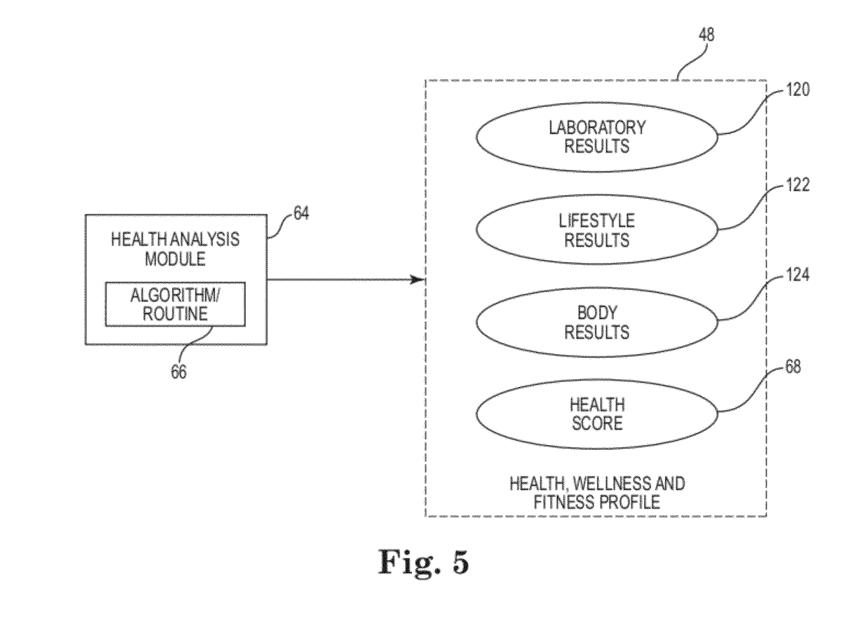

In some embodiments, the algorithm or routine 66 is further configured to generate a health score 68 for each individual 20 as part of their health, wellness, and fitness profile 48. The health score 68 indicates the individual's overall health, wellness, and fitness status, and comprises a whole number between 100 and 4 with a score of 100 representing excellent health and a score of 4 representing poor health. An example of a sample health, wellness, and fitness profile 48 and associated health score 68 for an individual 20 is described further herein with respect to FIG. 5.

FIG. 3 is a schematic view showing an example process 70 for gathering data and analyzing an individual's health, wellness, and fitness status using the system 10 of FIG. 1. FIG. 3 may represent, for example, a process of gathering data from individuals using the scheduling/data input and screening stations 30, 32 in FIG. 1. The process may begin generally at block 72 by obtaining an eligibility file for individuals 20 eligible for participation within a health plan 22, 24, 26 offered by an employer. The eligibility file can comprise, for example, an electronic file of all employees of a company eligible for participation within a health or fitness program at a health club. The eligibility file can also comprise an electronic file of individual members that, if qualified through an approval process of the system 10, may be provided certain incentives such as health premium reductions or credits. In some embodiments, the eligibility file includes a unique identification number associated with each individual (e.g., an employee number), each individual's first and last name, each individual's date of birth, each individual's gender, as well as other information. The types of data contained within the eligibility file may vary depending on the information required by the health club, by the employer, or a combination of both.

Individuals that choose to enroll in the plan and generate a health, wellness, and fitness profile 48 may access a special web-site (e.g., via the scheduling/data input station 30) (block 74), and are prompted to create an on-line account (block 76) that can be later accessed by the individual to input data and review the health, wellness, and fitness profile 48 and health score 68 generated by the health analysis module 64. During the account setup process, the individual 20 is prompted to enter identifying information such as the individual's mailing address, e-mail address, telephone number, date of birth, gender, and emergency contact information. In some embodiments, data contained within the eligibility file such as the individual's date of birth and employee number can be used to confirm the individual's identity to ensure that the individual's data and profile are correctly matched with the information contained in the eligibility file. If the individual is already an existing member of the health club, the account setup process may be simplified by populating the account data with the membership data already existing on file at the health club.

Upon creating an account, the individual 20 may then be prompted to complete a consent form for participation in the plan, and for providing limited third-party access to the individual's health-related data as well as the health, wellness, and fitness profile 48 and health score 68 (block 78).

The individual 20 is then prompted to complete a health risk assessment questionnaire that assesses the individual's health, wellness, and fitness status (block 80). The questionnaire may contain questions about the individual's primary healthcare physician, questions about the individuals' medical history, questions about the individuals' exercise, nutrition, and lifestyle choices and goals, and questions about the individual's emotional status. Example questions relating to an individual's lifestyle choices can include, for example, questions determining whether the individual currently uses tobacco or drinks alcohol. Example questions relating to an individual's emotion status can include questions on whether the individual has or is currently being treated for a mental illness (e.g., depression), or has experienced a significant change in activity level within the past few months. The types of questions presented to the individual 20 may vary depending on the specific requirements of the individual's health plan 22, 24, 26. For example, some employers may require that all questions be answered in order to enroll in a particular plan whereas other employers may require that only some of the questions be answered.

In some embodiments, an in-person or telephone evaluation may also be performed to determine the individual's readiness and/or willingness to participate in the program (block 82). In certain embodiments, for example, the individual 20 may be prompted to schedule a meeting with a health and wellness coach to determine the reason or reasons for entering into the plan, and to inform the individual 20 about the specifics of the program. In some embodiments, the individual's answer to a particular question on the questionnaire may trigger a flag requiring the individual 20 to receive a consultation or undergo an evaluation before enrolling in the plan. If, for example, the individual 20 indicates on the questionnaire that they are currently experiencing high levels of stress or symptoms of depression, the individual may be prompted to schedule an in-person consultation to determine their ability to enroll in the plan.

The process 70 can further include the scheduling of a screening session in order to evaluate one or more health-related parameters (block 84). As used herein, the term “health-related” broadly includes any measurable parameter relating to an individual's current or past health, wellness, and/or fitness status. The screening session can be conducted by a technician certified to conduct certain tests (e.g., a phlebotomist if a lipid panel is to be provided and not a fingerstick). The screening session can be performed on-site at the health club or at a location remote from where the individual normally exercises. As indicated generally at block 86 in FIG. 3, and in some embodiments, the screening session includes conducting a blood pressure screening test (block 88) for measuring the participant's blood pressure, conducting a body composition screening test (block 90) for measuring the individual's body composition (e.g., height, weight, body mass, body water composition, etc.), a blood screening test (block 92) for measuring one or more blood related parameters (e.g., LDL/HDL levels, total cholesterol level, triglyceride level, glucose level, etc.) and a fitness screening test (block 94) for measuring one or more fitness related parameters (e.g., anaerobic threshold, fat and caloric utilization, etc.). Other screening tests may also be performed in addition to or in lieu of these tests. In certain embodiments, the types of screening tests that are performed may vary based on the specific requirements of the individual's plan.

Depending on the type of screening performed, laboratory samples 40 obtained from the individual 20 during each screening may be sent out to the laboratory network 16 for further testing or evaluation (block 96). If, for example, the individual 20 is required to take a blood test to screen for tobacco use and cholesterol levels, a blood specimen may be sent to a laboratory within the laboratory network 16 authorized to handle such tests. In some embodiments, a message is also transmitted to the physicians network 14 indicating that a blood test is to be performed by the laboratory network 16 (block 98). The results from the blood test are then sent to the physicians network, which analyzes the laboratory results (block 100) and provides the laboratory results and any physicians comments back to the health club network (block 102).

The health analysis module 64 is then configured to automatically determine a health, wellness, and fitness profile (block 104) and health score (block 106) based on the information acquired from the questionnaire, data acquired via the screening stations, laboratory results obtained from the laboratory network, data made available by the individual's healthcare provider, and any additional data provided by the physicians network 14 in analyzing the health-related data and/or laboratory results. In some embodiments, additional data provided to the health analysis module 64 can also be used for generating the profile and score. If, for example, the individual 20 is interviewed by a health and wellness coach to determine their readiness and/or willingness to participate in a training program, additional data obtained during the interview can be entered into the database 42 and used by the health analysis module 64 in generating the profile and score.

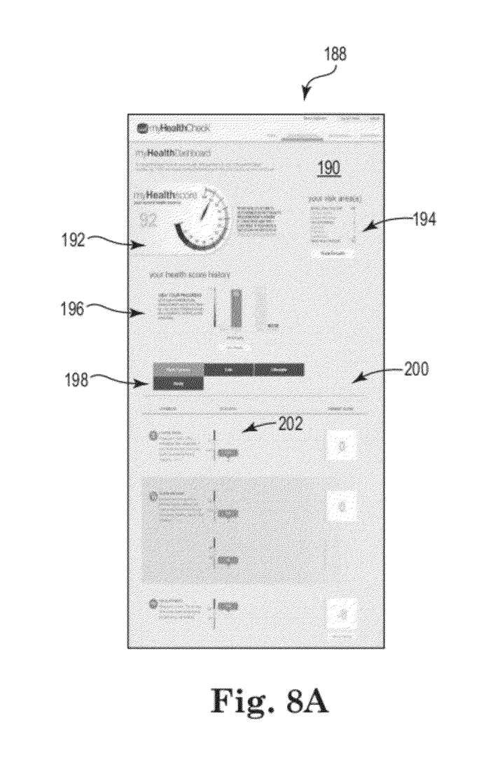

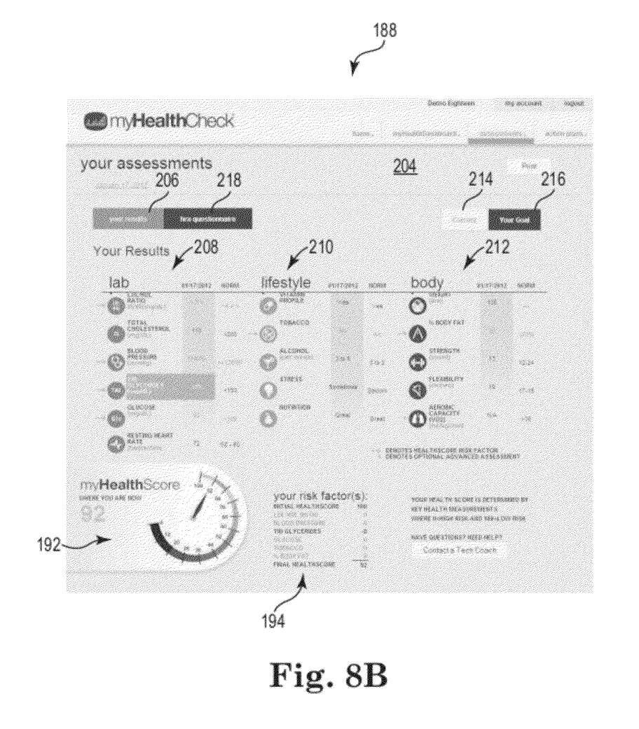

Once generated, the profile and score is made available to the individual via their account (block 108). In certain embodiments, for example, the profile and score may be displayed as a dashboard screen on a graphical user interface made available to the individual 20 by accessing their account. An example of a graphical user interface configured for displaying a health, wellness, and fitness profile and health score is further described herein with respect to FIGS. 8A-8B.

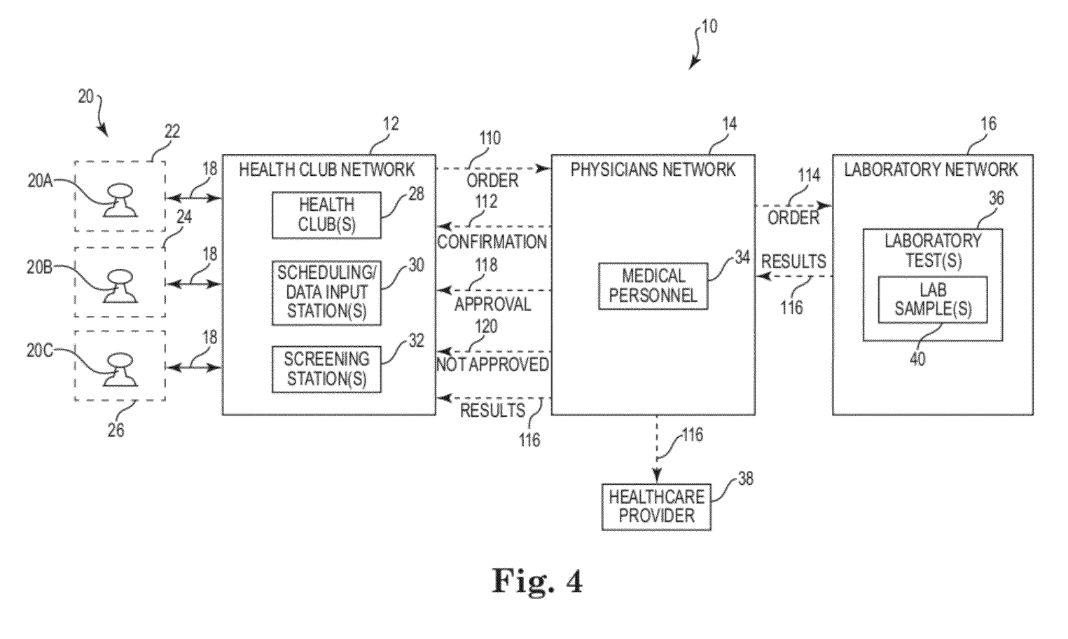

FIG. 4 is a schematic view showing an example approval process for approving individuals eligible for participation in an employer sponsored health plan using the system 10 of FIG. 1. FIG. 4 may represent, for example, several example steps that can be used by the system 10 of FIG. 1 to analyze an individual's 20a, 20b, 20c eligibility to enroll in a particular plan 22, 24, 26 offered to members by their employer.

As shown in FIG. 4, the approval process may begin when an order request 110 is received by the physicians network 14 from the health club network 12, requesting that laboratory testing be performed and reviewed by authorized medical personnel 34 such as a physician or nurse practitioner. In some embodiments, for example, the order request 110 may be generated automatically when an individual schedules a screening session at one of the screening stations 32 or at the conclusion of a screening session at one of the screening stations 32. Alternatively, the order request 110 may be generated manually by a technician, health and wellness coach, or other authorized individual. In some embodiments, the process of obtaining approval from the physicians network 14 may occur immediately such as upon the scheduling of a screening session using one of the scheduling/data input stations 30. In other embodiments, the process of obtaining approval from the physicians network 14 may be delayed for a period of time (e.g., 24 hours) in order to obtain verification from the individual 20 that he or she wishes to proceed with the approval process.

Once an order request 110 is received by the physician's network 14, an acknowledgement message 112 is sent back to the health club network 12 indicating that the order request 110 was received. In some embodiments, the acknowledgement message 112 comprises a verification e-mail that is sent to the individual 20, prompting the individual 20 to log into their account and finish completing any remaining questions on their health-assessment questionnaire.

If laboratory testing is to performed and is approved, the physicians network 14 sends a laboratory order request 112 to the laboratory network 16, prompting the network 16 to schedule a laboratory test 36 to be performed once the lab sample or samples 40 are received from the screening station 32. The results 116 from the laboratory testing are then sent back to the physicians network 14 for further analysis by a physician, nurse practitioner, or other authorized medical personnel 34.

The results 116 from the laboratory testing are then reviewed by medical personnel 34 to determine whether the individual 20 is eligible for enrollment in the plan 22, 24, 26. In some embodiments, the determination of whether the individual 20 is eligible for enrollment in the plan 22, 24, 26 includes comparing the laboratory results and health-related data against eligibility criteria provided by the individual's employer and/or the employer's health insurance provider. If the individual 20 is eligible, the physicians network 14 transmits an approval confirmation 118 to the health club network 12, indicating that the individual 20 is approved for the plan. If the individual has been approved for enrollment in the plan 22, 24, 26, the approval confirmation 118 can include an e-mail message to the individual 20 prompting the individual 20 to return to their account and complete any remaining questions on the questionnaire, if necessary. If, on the other hand, the laboratory results 116 indicate that the individual 20 is not eligible for enrollment in the plan 22, 24, 26, or requires immediate medical attention, the physician network 14 provides a different message 120 to the individual 20 indicating that he or she is not approved for the plan and/or urging them to seek immediate medical attention.

The results 116 from the laboratory testing as well as any medical notes or diagnosis made by the medical personnel 34 are transmitted to the health club network 12 and stored for later analysis. If consent has been given, and in some embodiments, the laboratory results 116 are also shared with the individual's healthcare provider 38.

FIG. 5 is a schematic view showing an example of a health, wellness, and fitness profile 48 generated by the health analysis module 64 of FIG. 2. As shown in FIG. 5, the profile 48 includes a laboratory results section 120, a lifestyle results section 122, and a body composition results section 124. The laboratory results section 120 comprises the results of any laboratory testing that has been performed including, but not limited to, any health screenings for determining the individual's blood pressure, resting heart rate, cholesterol, LDL/HDL ratio, glucose levels, and triglyceride levels. The lifestyle results section 122 comprises information relating to the individual's lifestyle choices including, but not limited to, tobacco use, vitamin profile, alcohol consumption, stress levels, and nutrition. The body composition results section 124 comprises body and fitness related information including, but not limited to body, fat percentage, weight, height, strength, flexibility, and aerobic capacity (VO2).

The health, wellness, and fitness profile 48 further includes a health score 68 generated by the health analysis module 64. In some embodiments, for example, the health score 68 is generated based on the individual's blood pressure, body fat percentage, LDL/HDL ratio, tobacco usage, glucose levels, and triglyceride levels. Other factors in addition to, on in lieu of, these factors can also be used to determine the health score. In some embodiments, for example, the individual's aerobic capacity (VO2 max) is used as an additional factor to determine the individual's health score.

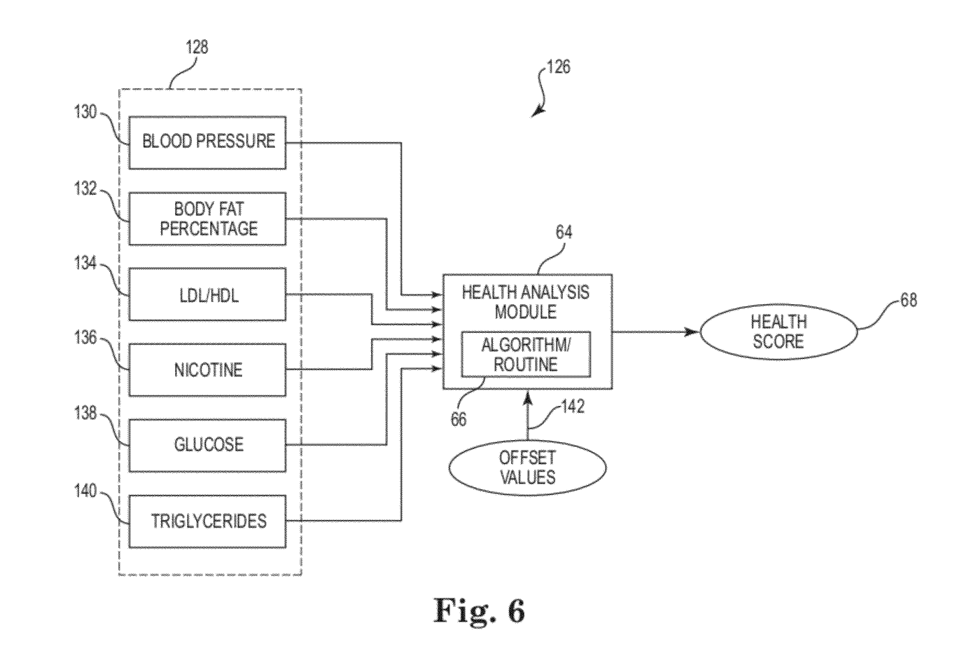

FIG. 6 is a schematic view showing an example process 126 for generating a health score 68. FIG. 6 may represent, for example, several example steps used by the health analysis module 64 of FIG. 2 to determine a health score 68 based on the questionnaire data, health-related data, and laboratory results acquired using the system 10 of FIG. 1.

In the embodiment of FIG. 6, the health analysis module 64 is configured to receive, as input metrics 128, a blood pressure metric parameter 130, a body fat percentage metric parameter 132, a cholesterol (LDL/HDL ratio) metric parameter 134, a nicotine metric parameter 136, a glucose metric parameter 138, and a triglycerides metric parameter 140.

The blood pressure metric parameter 130 comprises the individual's systolic and diastolic blood pressure obtained via the sphygmomanometer 52. The body fat percentage metric parameter 132 comprises data obtained via the body analyzer 50, and is dependent on the individual's age and gender. The cholesterol (LDL/HDL) metric parameter 134 comprises data relating to the individual's LDL and HDL levels obtained by laboratory tests performed on blood samples taken by the blood test kit 54. The nicotine metric parameter 136 indicates whether the individual is a tobacco user, and can be determined based on self-reporting data from the individual and/or laboratory tests performed on a blood sample taken by the blood test kit 54. The glucose and triglyceride metric parameters 138, 140 relate to the individual's glucose and triglyceride levels obtained by laboratory tests performed on blood samples taken by the blood test kit 54.

Based on these input metrics 128, the health analysis module 64 determines a health score 68 by determining offset values 142 associated with each metric parameter 130, 132, 134, 136, 138, 140, and then subtracting these offset values 142 from an initial score. In certain embodiments, for example, the health analysis module 64 begins at an initial health score of 100, indicating an individual with excellent health and lifestyle choices. Offsets values 142 of either 0, 8, or 16 are then subtracted from the initial score depending on the value associated with each metric parameter 130, 132, 134, 136, 138, 140. From the initial score, the health analysis module 64 subtracts the offset values 142 associated with each metric parameter 130, 132, 134, 136, 138, 140 to obtain a final health score 68.

An example table listing sample offset values 142 that can be associated with each metric 128 for an individual aged 30 to 39 is reproduced in Table 1 below:

TABLE 1
(Example Health Score Offsets For Individuals Age 30 to 39)

| METRIC | 0 POINTS | −8 POINTS | −16 POINTS |
|---|---|---|---|
| Blood Pressure | ≦139/89 | 140/90 to 159/98 | ≧160/99 |
| (Systolic/ | | | |
| Diastolic) | | | |
| Body Fat % | <22% (Male) | 22% to 27% (Male) | >27% (Male) |
| | <23% (Female) | 23% to 32% (Female) | >33% (Female) |
| LDL/HDL | <4.4:1 | 4.5:1 to 5:1 | >5:1 |
| Ratio | | | |
| Nicotine | No | Yes (If Completed | Yes |
| | | Smoking Cessation | |
| | | Program) | |
| Glucose | <100 | 100 to 125 | ≧126 |
| (mg/dL) | | | |
| Triglycerides | <149 | 150 to 200 | >200 |
| (mg/dL) | | | |

The offset values 142 for each metric 128 are weighted such that values within a healthy range do not offset the health score whereas values within a second (i.e., moderately unhealthy) range offset the health score by −8 and values within a third (i.e., significantly unhealthy) range offset the health score by −16. With respect to blood pressure, for example, a systolic/diastolic blood pressure that is at or less than 139/89 results in zero offset, a systolic/diastolic blood pressure of between 140/90 to 159/98 results in an 8 point offset, and a systolic/diastolic blood pressure that is at or greater than 160/99 results in a 16 point offset to the initial score.

For some metric parameters such as body fat percentage, the offset values 142 vary based on the individual's age and gender. Tables 2 and 3 reproduced below, for example, show example offset values 142 associated with body fat percentages in men and women over several age ranges:

TABLE 2
(Example Score Offsets For Men Based on Age)

| Age | 0 Points | −8 Points | −16 Points |
|---|---|---|---|
| 20-29 | <19% | 19% to 26% | >26% |
| 30-39 | <22% | 22% to 27% | >27% |
| 40-49 | <24% | 24% to 29% | >29% |
| 50-59 | <26% | 26% to 30% | >30% |
| 60+ | <27% | 27% to 31% | >31% |

TABLE 3
(Example Score Offsets For Women Based on Age)

| Age | 0 Points | −8 Points | −16 Points |
|---|---|---|---|
| 20-29 | <22% | 22% to 32% | >32% |
| 30-39 | <23% | 23% to 33% | >33% |
| 40-49 | <26% | 26% to 35% | >35% |
| 50-59 | <30% | 30% to 38% | >38% |
| 60+ | <31% | 27% to 39% | >39% |

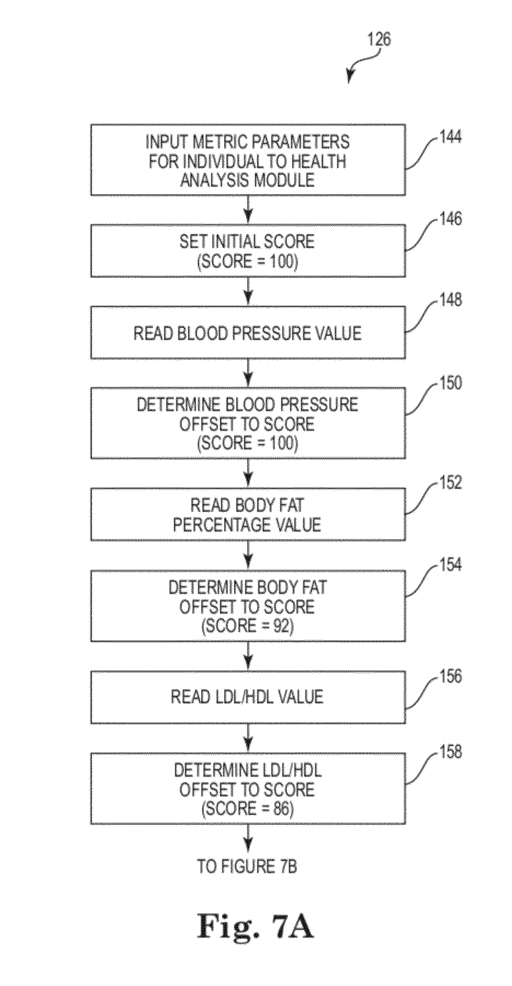

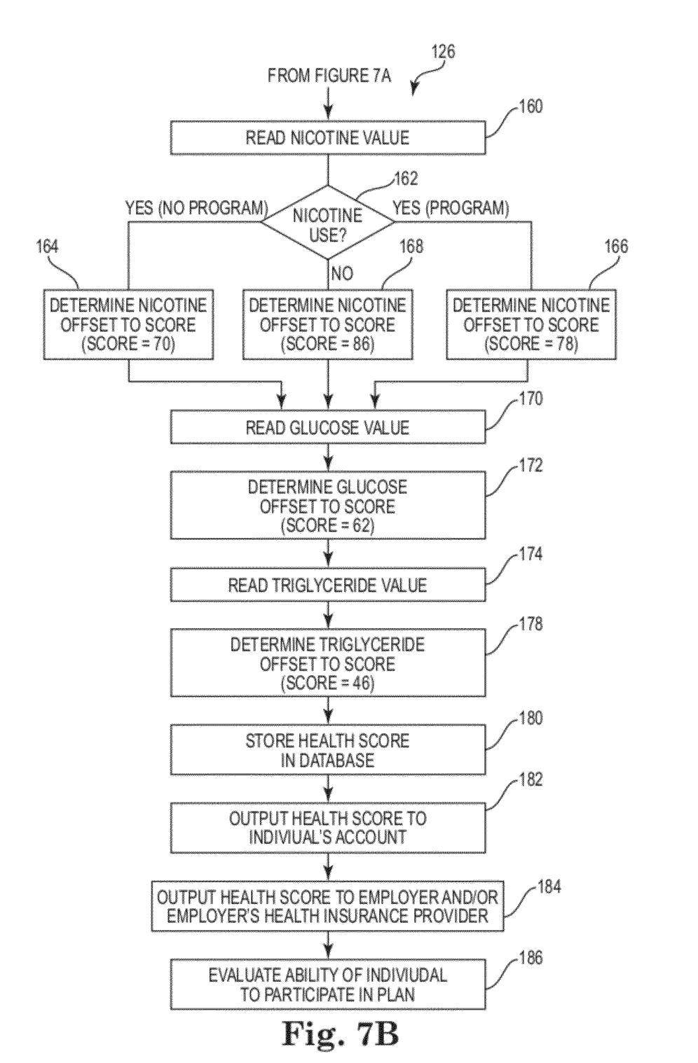

FIGS. 7A-7B is a flow diagram showing an example implementation of the process 126 of FIG. 6 for determining an individual's health score. The process 126 may begin generally at block 144 in which stored input metrics 128 for the individual are inputted to the health analysis module 64. In certain embodiments, for example, the stored input metrics 128 comprise data stored within the database 42 maintained by the health club, or a third-party database 62, as part of the health club network 12 of FIG. 2. For purposes of illustration, an example table showing example input metrics 128 for a 45 year-old male is shown in Table 4 below.

TABLE 4
(Input Metrics For Male, Aged 45)

| METRIC | PARAMETER VALUE |
|---|---|
| Blood Pressure | 120/80 |
| (Systolic/Diastolic) | |
| Body Fat % | 25% |
| LDL/HDL Ratio | <4.8:1 |
| Nicotine | Yes (No Program) |
| Glucose (mg/dL) | 105 |
| Triglycerides (mg/dL) | 205 |

To determine the health score 68, the health analysis module 64 sets a initial score such as 100 (block 146), and then determines offsets for each parameter value based on the offset values 142 contained in Table 1. Using the sample health data contained in Table 4, for example, the health analysis module 64 reads the blood pressure value (i.e., “120/80”), and determines the corresponding offset value (i.e., “0”) associated with this value (block 148). Since the blood pressure is within the healthy range (i.e., below 139/89), the score is not offset, and thus remains at 100.

The health analysis module 64 next reads the body fat percentage value (i.e., “25%”) (block 152), and determines the corresponding offset value (i.e., “−8”) associated with this value (block 154). The score is then adjusted, resulting in a revised score of “92.”

The health analysis module 64 next reads the LDL/HDL ratio value (i.e., “4.8:1”) (block 156), and determines the corresponding offset value (i.e., “−8”) associated with this value (block 158). The score is then adjusted, resulting in a revised score of “86.”

The health analysis module 64 next reads the nicotine value (i.e., “Yes”) (block 160). If at decision block 162 the input value indicates that the individual is a tobacco user and has not completed a smoking cessation program, the module 64 determines the corresponding offset value (i.e., “−16”) associated with this value (block 164). The score is then adjusted (block 164), resulting in a revised score of “70.” If at decision block 162 the input value indicates that the individual is a tobacco user and has successfully completed a smoking cessation program, the module 64 would credit the individual 8 points, resulting in a different score (i.e., “78”) (block 166). Otherwise, if at decision block 162 the input indicates that the individual does not use tobacco, the health analysis module 64 would not offset the score (block 168).

The health analysis module 64 next reads the glucose value (i.e., “105”) (block 170), and determines the corresponding offset value (i.e., “−8”) associated with this value (block 172). The score is then adjusted, resulting in a revised score of “62.”

The health analysis module 64 next reads the triglycerides value (i.e., “205”) (block 174), and determines the corresponding offset value (i.e., “−16”) associated with this value (block 176). The score is then adjusted, resulting in a final health score of “46.”

In some embodiments, a health score greater than 84 indicates that the individual is generally healthy, a health score of between about 52 to 84 indicates that the individual is moderately unhealthy, and a health score below 52 indicates that the individual is significantly unhealthy and in poor health.

The final health score (i.e., “46”) is then stored in the database (block 180) and outputted to the individual's account for viewing (block 182). In some embodiments, the health score generated by the health analysis module 64 is further provided to the individual's health insurance provider (block 184). The health score can then be used by the employer and/or the employer's health insurance provider for evaluating the individual's ability to participate in a particular plan offered by the employer (block 186).

FIGS. 8A-8B are several views showing an example graphical user interface 188 configured for displaying an individual's health, wellness, and fitness profile and health score. FIGS. 8A-8B may represent, for example, several screens of a graphical user interface 188 that can be viewed by an individual upon completing the process 70 of FIG. 3.

As can be seen in a first view shown in FIG. 8A, the graphical user interface 188 is configured to display a dashboard screen 190 including a health score dial 192 graphically showing the individual's final health score, a risk areas section 194 indicating the metric parameters (i.e., “risk areas”) and associated offset values that contributed to the individual's health score, and a historical data section 196 showing any previous health scores and associated goals for the individual. A menu button bar 198 on the dashboard screen 190 provides the individual with the choice of viewing several additional screens for viewing their health-related data and laboratory results.

Selecting one of the buttons on the button bar 198 causes the dashboard screen 190 to display a list of parameters 200 along with a graph 202 for each parameter indicating the individual's levels relative to each of the three ranges used by the health analysis module in determining the offset values. For example, and as shown in FIG. 8A, when the “risk factors” icon button is selected on the button bar 198, the dashboard screen 190 displays a list of risk assessment parameters along with the corresponding metric parameter value and offset value. The value of each metric parameter can be displayed in graphical form along with a means for indicating the value within the three offset value ranges used by the health analysis module in computing the health score. In some embodiments, for example, each parameter can be displayed alongside a color bar showing in green a first range indicating that the metric value is within a healthy range, yellow indicating that the metric value is within the moderately unhealthy range, and red indicating that the metric value is within a significantly unhealthy range. Other configurations are also possible.

FIG. 8B is a view showing another screen of the graphical user interface 188 that can be accessed to view a summary page 204 of the individual's health, wellness, and fitness profile and health score. As shown in FIG. 8B, selection of an icon button 206 causes the interface 188 to display a listing of the individuals' laboratory results 208, lifestyle-related parameters 210, and body composition related parameters 212 along with normal values for each parameter. The individual may toggle back and forth between viewing actual results and their goals via a set of icon buttons 214, 216 on the page 204. If desired, the individual may also select a “HRA questionnaire” icon button 218 in order to display the list of questions and answers from their completed health risk assessment questionnaire.

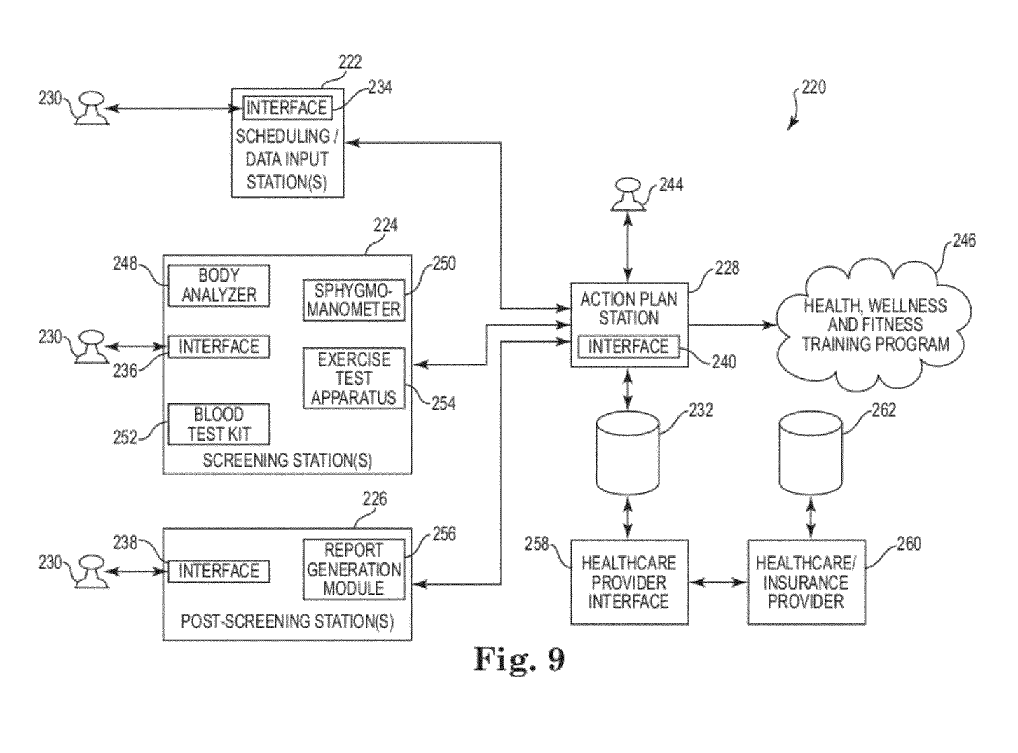

FIG. 9 is a schematic view showing a system 220 for customizing a health, wellness, and fitness training program in accordance with an illustrative embodiment. The system 220, illustratively a system for customizing programs for participants in a health club environment, includes a scheduling/data input station 222, a screening station 224, a post screening station 226, and an action plan station 228. The stations 222, 224, 226, 228 can comprise, for example, one or more physical or virtual locations that can be accessed by participants 230 in person and/or over a computer network for gathering and inputting data to a database 232. In certain embodiments, for example, one or more of the stations 222, 224, 226, 228 can comprise a separate customer service area located within a health club that can be used to gather information relating to the health, lifestyle, and goals of participants 230 that use the health club. One or more of the stations 222, 224, 226, 228 can also include a computer interface 234, 236, 238, 240 to permit a participant or authorized personnel (e.g., a personal trainer, technician, or health and wellness coach) to log-in and supply the database 232 with information relating to the participant's health, lifestyle, and goals. As discussed further herein, information gathered and stored in the database 232 can be used by a health and wellness coach 244 to develop a customized health, wellness, and fitness training program 246 for each participant 230. In some embodiments, the health, wellness, and fitness training program 246 comprises a program offered to employees as part of an employer sponsored health plan, as described, for example, with respect to the system 10 of FIG. 1.

Although several distinct stations 222, 224, 226, 228 are shown in the embodiment of FIG. 9, in other embodiments one or more of the stations 222, 224, 226, 228 can be grouped together or can be further separated into additional subgroups. Moreover, some of the stations 222, 224, 226, 228 may comprise physical locations (e.g., at a health club or remote site) whereas other stations 222, 224, 226, 228 may comprise virtual stations that are accessible on-line via a network connection. For example, in some embodiments the scheduling/data input station 222 may comprise an Internet or intranet portal that can be accessed via a computer interface 234 whereas the screening station 224 can comprise a physical location at the health club or an off-site location equipped with testing equipment for performing health screenings on participants 230.

The interface 234 for the scheduling/data input station 222 is configured to gather information from participants 230 and to schedule health-related screenings to be performed at one or more of the screening stations 224. In some embodiments, for example, the interface 234 comprises a computer terminal that can be used to access an on-line scheduling program maintained by the health club for scheduling an in-person screening with a technician at one of the screening stations 224. The interface 234 can also be configured to prompt the participant 230 to enter information into the database 232 prior to scheduling a screening session. In certain embodiments, for example, the scheduling/data input station 222 may prompt the participant 230 to log-in to an Internet or intranet site and complete a health and lifestyle questionnaire or par-Q form that can be later analyzed by the participant's wellness coach 244 to generate a customized health, wellness, and fitness program 246 specifically tailored for that participant 230. Example information that can be obtained via the questionnaire can include, but are not limited to, demographic or personal information such as the participant's name, address, telephone number, e-mail address, date of birth, gender, emergency contact information, membership number, and health insurance plan number. Information pertaining to the participant's lifestyle can also be gathered via the scheduling/data input station 222 including, but not limited to, the participant's diet, the types of vitamins or supplements taken, the regularity of smoking and alcohol consumption, the participant's life-stress level, and the participant's physical activity level.

For each category of lifestyle information gathered, the interface 234 may prompt the participant 230 to select a goal to be attained following the completion of the health, wellness, and fitness training program 246. If, for example, the participant 230 indicates that their current alcoholic consumption level is 10+ drinks per day, the participant 230 may select a goal of 0 to 2 drinks per day to be achieved via the training program 246. In some embodiments, the goals associated with the answers to the lifestyle questionnaire or par-Q can be used by the participant's health and wellness coach 244 to customize a health, wellness, and fitness training program 246 that takes into consideration that participant's specific goals and to schedule training, motivation and check-up sessions with the participant 230.

Each screening station 224 is used for performing health screenings that can be used in conjunction with other information for generating the health, wellness, and fitness training program 246. In some embodiments, the screening station 2224 can comprise a dedicated area or location within a health club that can be used for performing health screenings on participants 230. In other embodiments, the screening station 224 can comprise one or more remote stations located off-site from the health club. For example, the screening station 224 can comprise a dedicated site at the participant's corporation, a mobile unit, a health clinic, or other remote location where participants can be privately screened by a physician, nurse, metabolic specialist, or other authorized individual. In certain embodiments, multiple screening stations 224 may be used to screen each participant 230. For example, the screening station 224 can include a blood screening station for taking a fingerstick or lipid profile of the participant and a body composition and stress-test screening station for analyzing the participant's body composition.

Each screening station 224 can be used to gather various types of health-related data which, in combination with the demographic, lifestyle, and goal information, can be used to create a comprehensive profile for the participant 230. In some embodiments, for example, the screening station 224 can include a body analyzer 248 that can be used to gather height, weight, and body composition data from each participant 230. In certain embodiments, the body composition data from the participant can be gathered from a body composition analyzer such as the InBody 520® analyzer available from Biospace of Los Angeles, Calif. Other means for analyzing body composition can also be employed. The data received from the participant 230 via each screening station 224 as well as other information supplied by the participant 230 and health and wellness coach 244 can be used to generate an analysis of the participant's general health and wellness.

The screening station 224 can further include a sphygmomanometer 250 to take blood pressure measurements for each participant 230. In some embodiments, a blood test kit 252 can be used to take a small blood sample from each participant 230 for analyzing the participant's blood composition. Example blood parameters that can be measured include, but are not limited to, LDL/HDL levels, total cholesterol, triglyceride level, and glucose level.

The screening station 224 can further include an exercise test apparatus 254 for gathering cardiac and metabolic data for determining the participant's anerobic threshold during exercise as well as to determine how the participant's body utilizes fuel and how many calories are burned at specific heart rates. In some embodiments, for example, the apparatus 254 can include a respiration mask that analyzes the participant's respiration while the participant 230 performs an exercise routine such as riding on an exercise bike or running on a treadmill. In one embodiment, the exercise test apparatus 254 comprises a training system as the ACTIVE METALBOLIC TRAINING SYSTEM^{SM} available from New Leaf, Inc. of St. Paul, Minn. This information can be used in conjunction with the other information gathered from the participant to determine the participant's equivalent body age, aerobic capacity (VO2 max), as well as other parameters.

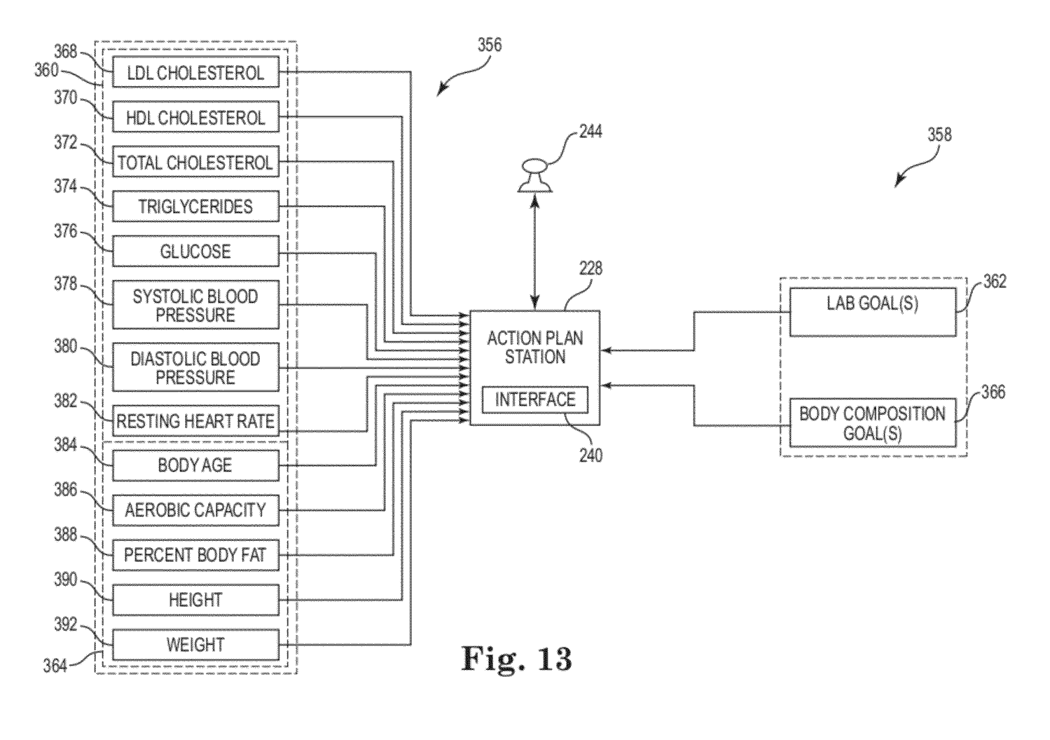

As with the lifestyle-related parameters gathered via the scheduling/data input station 222, the health-related parameters gathered via each screening station 224 can be used to determine appropriate goals for improving upon one or more of these parameters through the coordination of an appropriate health, wellness, and fitness training program 246. For example, at the conclusion of the cardiac and metabolic screening, the participant 230 may be provided with the results from the screening and prompted to select an appropriate goal for improving upon one or more of the tested parameters through a customized training program 246 that is reviewed with the participant 230 at the action plan station 226. In some embodiments, the action plan station 226 may automatically assign a goal to be achieved based on other selected goals, based on pre-programmed goals stored in the database 232, and/or based on information supplied by the wellness coach 244. Several illustrative health-related parameters that can be acquired via the stations 222, 224, 226, 228 are described further herein with respect FIG. 13.

Since the screening information gathered at each screening station 224 is obtained firsthand as compared to self-assessment information provided by the participant 230, the occurrence of errors associated with self-reporting or relying on outdated information is reduced. This permits the health and wellness coach 244 to customize health, wellness, and fitness training programs 246 based on a more accurate and complete profile of the participant's health.

The interface 238 for the post screening station 226 permits participants 230, the health and wellness coaches 244, as well as other individuals to review the participant's health and lifestyle parameters, and to determine appropriate goals for improving upon one or more of these parameters through the coordination of an appropriate health, wellness, and fitness training program 246. For example, at the conclusion of a blood screening, the participant 230 may be provided with the results from a blood composition analysis and prompted to determine an appropriate goal for improving upon one or more tested blood parameters through a customized training program 246 determined by the health and wellness coach 244. In the event the values for these parameters exceed a particular threshold, the participant 230 may also be urged to contact their healthcare provider to take further action, as needed.

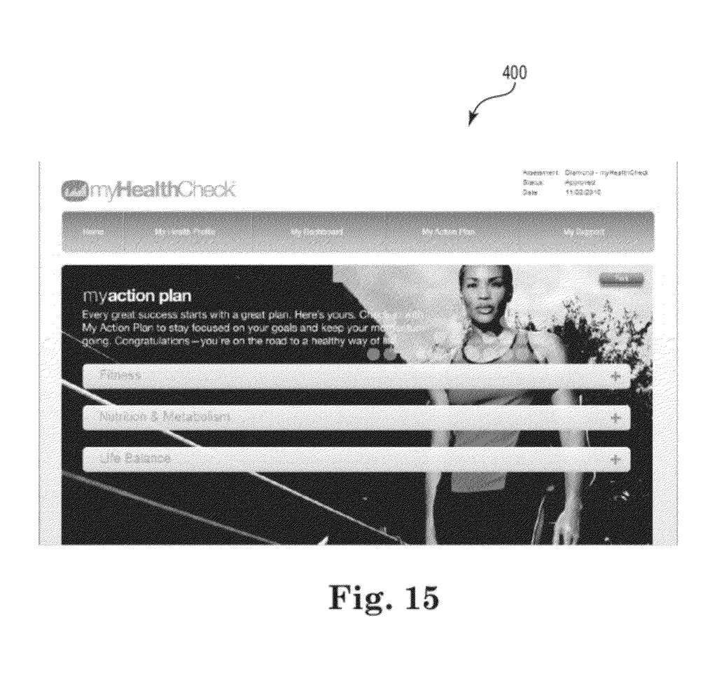

In some embodiments, the post screening station 226 can be used by technicians to populate data obtained during screening into the database 232. In some embodiments, for example, the post screening station 226 can be used by a technician to input data acquired from a screening test into the database 232 and/or to transmit the data directly to the participant 230 via one of the stations 222, 224, 226, 228. The database 232 can comprise a hard-drive, optical drive, memory unit or other suitable means for storing information acquired from participants 230 via each station 222, 224, 226, 228, the health and wellness coach 244, as well as information acquired from other sources. A report generation module 256 can be used to provide participants 230 with a comprehensive report on their health and lifestyle information, including any goals that are associated with such information. A example dashboard screen 400 that can be used for displaying action plan items and associated goals is show, for example, in FIG. 15.

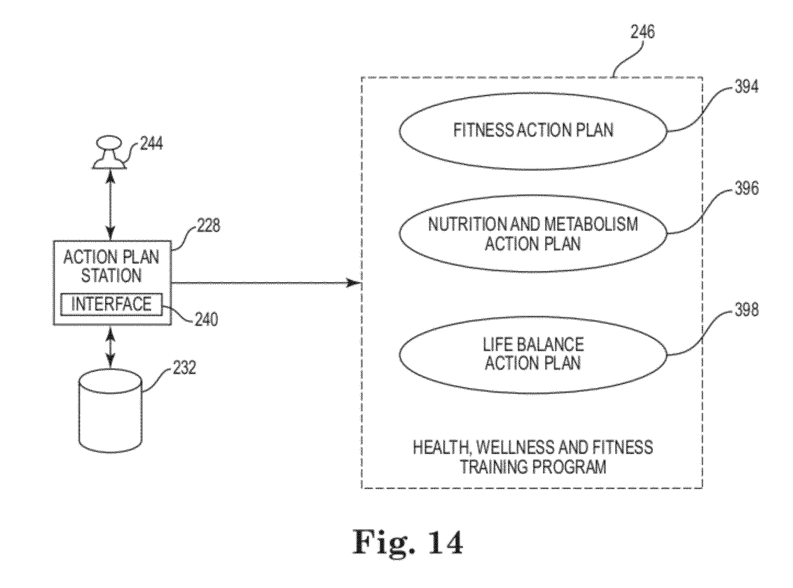

The action plan station 228 can be accessed by health and wellness coaches 244 to develop customized health, wellness, and fitness training programs 246 for participants 230 based on information that is gathered from each of the stations 222, 224, 226, 228. In some embodiments, the program 246 can be generated automatically using an algorithm or routine executable as computer readable instructions on a server, desktop computer, laptop computer, or other computing device that analyses the participant's information and then recommends an action plan that is then reviewed and/or further customized by the health and wellness coach 244. The algorithm or routine can also be integrated with other software and/or hardware used by the health club for managing workflow and other customer-related tasks. An example of a customized health, wellness, and fitness program 246 that includes multiple action plan components is described further herein with respect to FIG. 14.

In some embodiments, a healthcare provider interface 258 can be used to transmit data back and forth between the database 232 and a separate database maintained by a healthcare or insurance provider 260. In certain embodiments, for example, the healthcare provider interface 258 can be used to transmit historical health data into the database 232 for further analysis by the health and wellness coach 244 in generating a customized health, wellness, and fitness training program 246. Information acquired from each participant 230 can also be fed to a healthcare or insurance provider database 262 for later use by the provider 260. In some embodiments, for example, the interface 258 may permit a health insurer to monitor a participant's compliance with an action plan developed as part of a particular health, wellness, and fitness training program 246.

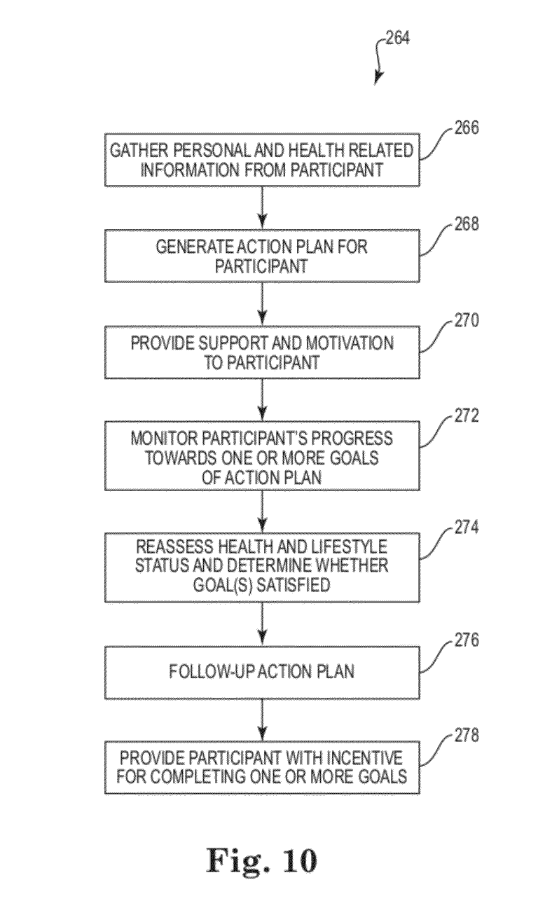

FIG. 10 is a flow diagram showing an illustrative method 264 for promoting health and wellness in participants using the system 220 of FIG. 9. The method 264 may begin generally at block 266, in which personal and health-related information is gathered from a participant. Information gathered from the participant can comprise self-reported information gathered from an on-line questionnaire or par-Q form, information gathered from an in-person or telephonic consultation, information gathered from the participant via one or more screening tests, information acquired from a health benefits provider or insurer, and/or other sources of information. The personal and health-related information can be acquired, for example, from responses to questions entered at one of the scheduling/data input stations, screening tests performed at one or more of the screening stations, and/or information provided by the participant's health and wellness coach.

Once the participant's information has been gathered and stored in the database, the health and wellness coach next determines an action plan for that participant (block 268). In some embodiments, the health and wellness coach may analyze various health and lifestyle parameters as well as the participant's goals using the action plan station, and from this information, generate a customized health, wellness, and fitness training program that focuses on exercise, nutrition, and lifestyle choices for that individual. In certain embodiments, for example, information regarding the participant's exercise, nutrition, and life-balance can be gathered from the participant and compared against optimal values for that category.

As a part of the action plan, support and motivation may be provided to the participant as needed and/or at scheduled times (block 270). If, for example, one of the goals is to lose weight, the system may send the participant a reminder or prompt the health and wellness coach to contact the participant to provide support in the form of encouragement and education. As a part of this encouragement, the health and wellness coach can also provide the participant with pertinent education tools and resources to help the participant achieve their goal.

In some embodiments, compliance with the participant's program can be monitored to ensure that the participant reaches their goal (block 272). Monitoring of the participant's progress can be accomplished based on self-reporting by the participant, reporting by the participant's health and wellness coach or other support personnel, or a combination of both. Monitoring of the participant's progress can also occur automatically. In certain embodiments, for example, the participant may be prompted to enter an identification number or swipe an identification card at the exercise equipment used to complete the training program. The equipment can then log the participant's equipment usage and provide that information to the database for later analysis by the health and wellness coach.

Once the participant completes their customized training program, the participant may then be prompted to reassess their health and lifestyle status to determine whether they satisfied one of their goals (block 274). In some embodiments, for example, the participant may be prompted to schedule a follow up screening test at one of the screening stations to determine if one or more of their goals have been achieved. The health and wellness coach may then determine a follow-up action plan to be followed by the participant (block 276), if desired.

To incentivize the participant to reach their goals, the participant may be given incentives at certain times during the course of their training program or when the goal has been achieved (block 278). For participants with health insurance, for example, the health insurance provider may provide the participant with continued payment or a reduction in health club membership dues. Other incentives may also be provided, which may or may not be based on the type of goal to be achieved and/or the particular training program.

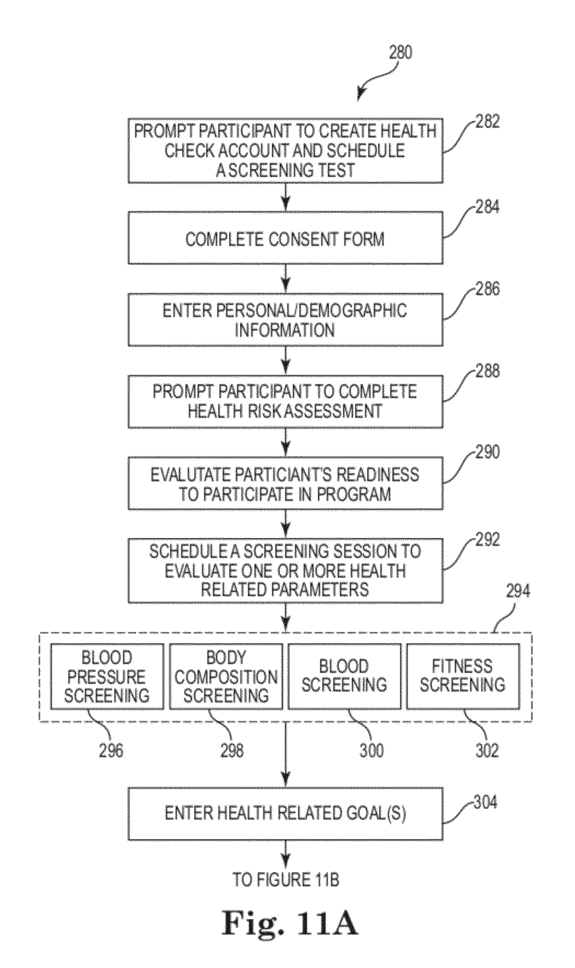

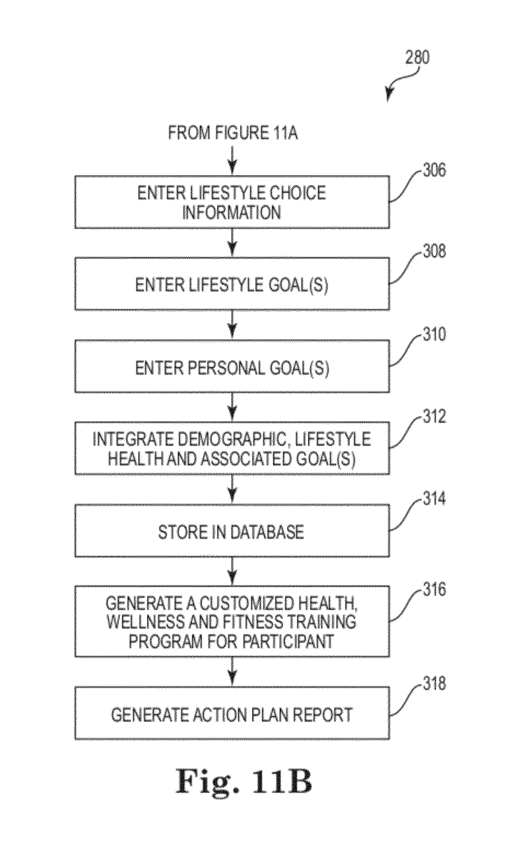

FIGS. 11A-11B is a flow diagram showing an example process 280 for generating a customized health, wellness, and fitness training program 246 using the system 10 of FIG. 9. The process 280 may represent, for example, several illustrative steps used for screening participants and developing an action plan based on personal, health, lifestyle and nutritional information gathered from a participant using one of the scheduling/data input stations and screening stations of FIG. 9. The process 280 may begin generally at block 282, in which a participant is prompted to create a health check account and to schedule a screening test. In certain embodiments, for example, the participant may be prompted to log-in to an on-line scheduling interface at one of the scheduling/data input stations and create an account that can later be used by the participant to review their health and lifestyle parameters/goals, and to track their progress at completing their training program. Further, an employer may provide certain incentives, such as premium reductions, for the participant.

Upon creating an account, the participant may then be prompted to fill out a consent form (block 284) and to enter additional personal/demographic information such as the participant's date of birth and gender (block 286). The participant can then be prompted to complete a health risk assessment (block 288) in the form of a questionnaire or par-Q form to assess the participant's health and lifestyle choices. In some embodiments, an evaluation may also be performed to determine the participant's readiness and/or willingness to participate in the program (block 290). In certain embodiments, for example, the participant may meet with a health and wellness coach to determine the reason or reasons for entering into the program, and to inform the participant about the process and what to expect during the training program.

The process 280 can further include the scheduling of a screening session in order to evaluate one or more health related parameters (block 292). As indicated generally at block 294, the participant can undergo a number of screening tests to gather health-related information about the participant. As used herein, health-related information broadly includes any measurable parameter relating to the participant's current or past health and wellness. Several example health-related parameters that can be used in determining a health, wellness, and fitness training program are described further herein with respect to FIG. 13.

The screening session can be performed on-site at the health club or at a location remote from where the participant normally exercises. Screening session tests can be conducted by a technician certified to conduct such tests. In the embodiment of FIG. 11, the screening session includes conducting a blood pressure screening test (block 296) for measuring the participant's blood pressure, a body composition screening test (block 298) for measuring the participant's body composition (e.g., height, weight, body mass, body water composition, etc.), a blood screening test (block 300) for measuring one or more blood related parameters (e.g., LDL/HDL levels, total cholesterol level, triglyceride level, glucose level, etc.) and a fitness screening test (block 302) for measuring one or more fitness related parameters (e.g., anaerobic threshold, fat and caloric utilization, etc.). Other screening tests may also be performed on the participant in addition to or in lieu of these tests.

Following the screening tests, the participant may be prompted to associate at least one goal to one or more of the health-related parameters measured during the screening process (block 304). If, for example, a body composition screening indicates that the participant has a weight of 200 pounds and a body age of 31, the participant, with the assistance of their health and wellness coach, may assign a goal to be achieved related to those parameters (e.g., weight≦190 pounds; body age=28). The selection of an appropriate goal can be made based on input from the participant's health and wellness coach, based on pre-programmed goals that can be selected by the participant (e.g., via a pull down menu on a graphical user interface), and/or automatically (e.g., via a computer algorithm or routine provided as part of the action plan station 228).

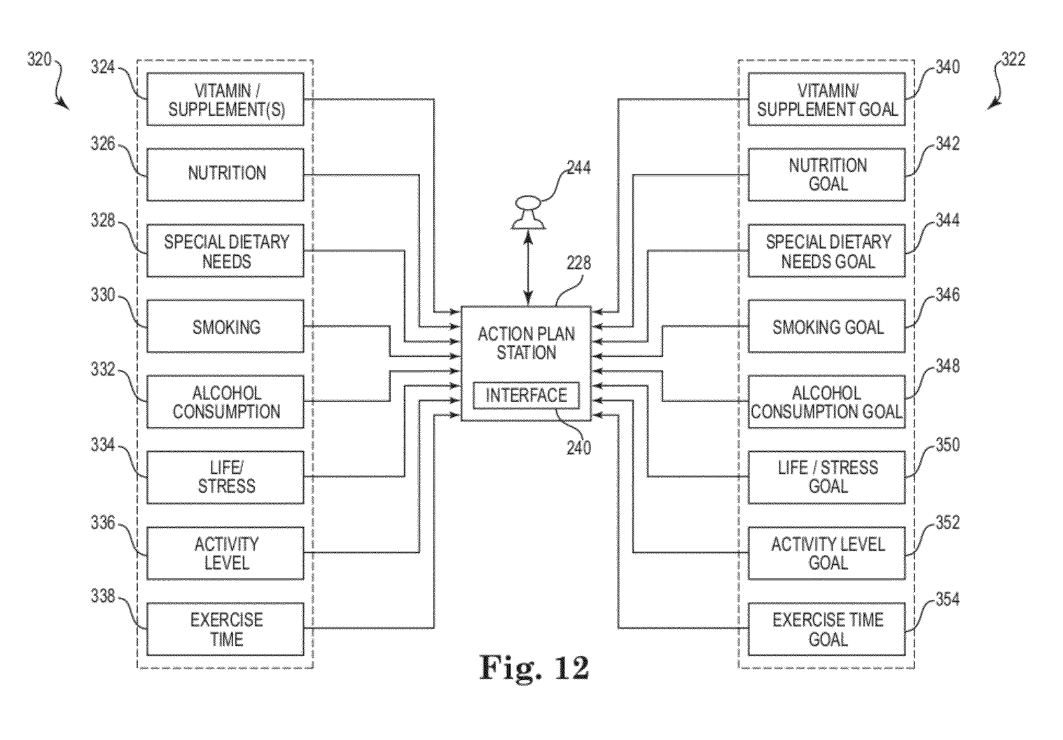

The participant may also be prompted to answer various questions regarding their current lifestyle choices (block 306). In some embodiments, for example, the participant may be prompted to complete an on-line questionnaire at one of the scheduling/data input stations that includes questions or prompts regarding the participant's diet, the types of vitamins or supplements taken, the regularity of smoking and alcohol consumption, as well as other lifestyle-related information. As used herein, lifestyle-related information broadly includes that information related to the participant's activity level, behavioral choices, and habits. Several example lifestyle parameters that can be used in generating a health, wellness, and fitness training program are described further herein with respect to FIG. 12.

In some embodiments, the system may prompt the participant to enter goals for one or more of the lifestyle-related questions that are answered (block 308). If, for example, the participant indicates in an on-line questionnaire that they currently consume 10+ drinks per day, the participant may be prompted to indicate a goal to be achieved (e.g., 0 to 2 drinks per day) for that particular lifestyle choice. In some embodiments, a goal may be associated with each lifestyle parameter gathered from the participant. In other embodiments, goals may be assigned to only a few or none of the lifestyle parameters. In some embodiments, the system may prompt the participant to select from a list of pre-determined goals. Alternatively, or in addition, the goals may be automatically generated by the system in response to feedback received from the participant and/or based on the participant's health status. The goals may also be based on feedback received from the participant's health and wellness coach.

The participant may also be prompted to provide one or more personal goals (block 310). For example, if the participant is planning on entering a triathlon on a particular date, the participant may provide information about the date of the competition along with the participant's personal time goals.

Information obtained from the screening process can be integrated with the participant's demographic, lifestyle, health, and goal information (block 312). The information obtained can be inputted into the database (block 314). Based on the various sources of information and associated goals gathered from the participant, the health and wellness coach then determines a customized health, wellness, and fitness training program for that participant (block 316).

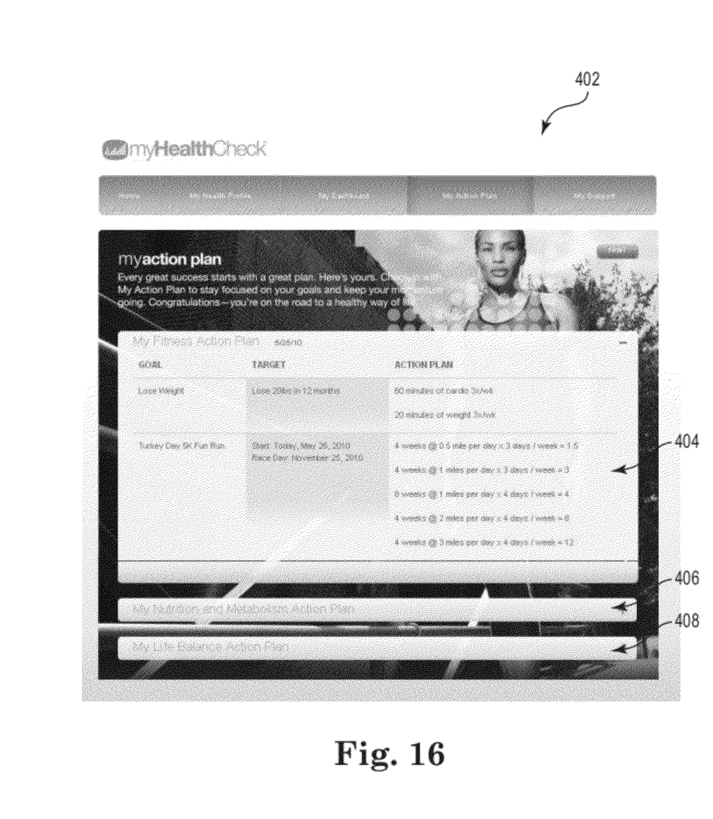

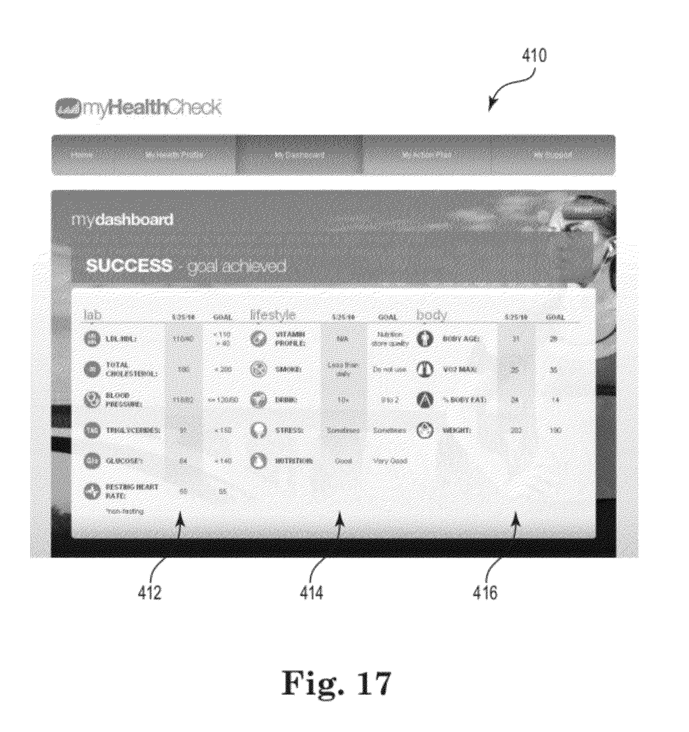

Information acquired from the participant as well as the action plan determined by the wellness coach can be fed to the report generation module (block 318), which can be accessed to view the action plan as well as a comprehensive report on the participant's health, lifestyle, and fitness information. In some embodiments, for example, a comprehensive report can be made available to the participant on-line via a graphical user interface that displays the participant's health, lifestyle, and fitness information as well as the action plan together on a single page or display screen. In other embodiments, the report may be provided to the participant as a paper copy, or in some other desired format. An example on-line dashboard that can display exercise, nutrition, and lifestyle action plan items is described further herein with respect to FIG. 16. An example on-line dashboard that can display a participant's health, lifestyle, and fitness information is described further herein with respect to FIG. 17.

FIG. 12 is a schematic view showing several example lifestyle parameters 320 and associated goals 322 that can be analyzed by a health and wellness coach 244 using the action plan station 228 of FIG. 9. As shown in FIG. 12, the action plan station 228 can be configured to receive a vitamin/supplement profile input parameter 324, a nutrition input parameter 326, a special dietary needs input parameter 328, a smoking input parameter 330, an alcohol consumption input parameter 332, a life-stress input parameter 334, an activity level input parameter 336, and an available exercise time input parameter 338. One or more other lifestyle parameters can also be provided to the action plan station 228, if desired.

The vitamin/supplement profile input parameter 324 relates to those vitamins or supplements regularly taken by the participant. The nutrition and special dietary needs input parameters 326, 328 relate to the participant's general nutrition and dietary needs. An example nutrition parameter may comprise a variable such as “good,” “fine,” or “poor.” An example of a special dietary need may comprise a variable such as “glucose intolerant,” “lactose intolerant,” or “low carbohydrates.”

The smoking and alcohol consumption input parameters 330, 332 relate to the participant's smoking and alcohol habits. An example smoking consumption input parameter may comprise variables such as “never,” “seldom,” “occasional,” or “frequent.” Example alcohol consumption input parameters can comprise variables such as “seldom: 0-2 drinks per day,” “frequent: 3-9 drinks per day,” or “heavy: 10+ drinks per day.”

The life-stress input parameter 334 relates to the participant's stress and anxiety levels. An example life-stress input parameter may comprise a variable such as “low stress,” “moderate stress,” or “high stress.” The activity level input parameter 336 relates to the general activity/fitness level of the participant. An example activity level input parameter 336 may comprise a variable such as “low activity, “moderate activity,” or “high activity.”

The available exercise time input parameter 338 relates to those dates and times that the participant is available to exercise, allowing the health and wellness coach 244 to customize the training program 246 based on the participant's schedule.

For each lifestyle category parameter 320, a goal 322 may be associated with that parameter and inputted to the action plan station 228 for analysis in conjunction with the lifestyle parameters 320. In the embodiment of FIG. 12, for example, example goals 340 that can be analyzed by the health and wellness coach 244 include a vitamin/supplement goal 340, a nutrition goal 342, a special dietary needs goal 344, a smoking goal 346, an alcohol consumption goal 348, a life-stress goal 350, an activity level goal 352, and an exercise schedule goal 354.

FIG. 13 is a schematic view showing several example health-related parameters 356 and associated goals 358 that can be analyzed by a health and wellness coach 244 using the action plan station 228 of FIG. 9. As shown in FIG. 13, the action plan station 228 can be configured to receive one or more lab parameters 360 and associated goals 362, and one or more body composition parameters 364 and associated goals 366. The lab and body composition parameters 360, 364 can be acquired, for example, based on screening tests, previous medical data, self-reporting data from the participant, or any combination of these.

Example lab parameters 360 that can be input to the action plan station 228 can include an LDL cholesterol input parameter 368, an HDL cholesterol input parameter 370, a total cholesterol input parameter 372, a triglycerides input parameter 374, a glucose input parameter 376, a systolic blood pressure input parameter 378, a diastolic blood pressure input parameter 380, and a resting heart rate input parameter 382. One or more other lab parameters 360 and associated goals 362 can also be provided to the action plan station 228, if desired.

Example body composition parameters 364 that can be input to the action plan station 228 can include an equivalent body age input parameter 384, an aerobic capacity (VO2 max) input parameter 386, a percent body fat input parameter 388, a height input parameter 390, and a weight input parameter 392. One or more other body composition parameters 364 and associated goals 366 can also be provided to the action plan station 228, if desired.

FIG. 14 is a schematic view showing an example health, wellness, and fitness training program 246 that can be generated based on the health and lifestyle parameters and associated goals gathered from a participant. The training program 246 can be created, for example, based on one or more of the lifestyle and health parameters inputted to the action plan station 228 as described herein with respect to FIGS. 12 and 13. As shown in FIG. 14, the training program 246 can comprise a number of individual action plans, including a fitness action plan 394, a nutrition and metabolism action plan 396, and a life balance action plan 398.

The fitness action plan 394 includes exercise and fitness-related activities to be completed by participants as part of their training program 246. An example fitness action plan 394 can include a long term goal of exercising 4 to 5 days per week doing 45 minutes of cardiovascular exercise and strength training. An example of a short term goal as part of a fitness action plan 394 can include walking on a treadmill 3 days per week in the morning for 15 minutes.

The nutrition and metabolism action plan 396 includes nutritional-related activities to be completed by participants as a part of their training program 246. An example nutrition and metabolism action plan 396 can include a long term goal of eating whole foods, 5-7 servings of fruit and vegetables per day, and eating regular meals. An example of a short term goal can include eating a healthy lunch 3 days per week and bringing an afternoon snack to work.

The life balance action plan 398 includes lifestyle-related activities to be followed by participants as a part of their training program 246. An example life balance action plan 398 can include a long term goal of reducing stress by increasing sleep and spending more time with family. An example of a short term goal can include going to sleep 30 minutes earlier, 3 days per week, and leaving work by 5:00 to have dinner with family.

FIG. 15 is a view showing an example dashboard screen 400 that can be used for displaying a list of action plan items for a customized health, wellness, and fitness training program. Using the dashboard screen 400 shown in FIG. 15, the participant can select one of a number of different window panes to view their current fitness, nutrition and metabolism, and life balance action plans and associated goals.

FIG. 16 is a view showing an example dashboard screen 402 that can be used for displaying action plan items from a customized health, wellness, and fitness training program. The screen 402 may represent, for example, a graphical user interface screen that can be accessed by a participant or a participant's health and wellness coach using one or more of the computer interfaces 234, 236, 238, 240 of FIG. 9.

As shown in FIG. 16, and in some embodiments, the dashboard screen 402 comprises a number of individual window panes including a fitness action plan window pane 404, a nutrition and metabolism action plan window pane 406, and a life balance action plan window pane 408. Each of the window panes 404, 406, 408 include one or more goals, a specific target associated with each goal, and one or more action plan items to be completed by the participant to achieve the goal. As an example, and as shown in the fitness action plan window pane 404 of FIG. 16, a general goal of “Lose Weight” may be specified along with a target of “Lose 20 lbs in 12 months.” Associated with the goal can include a fitness action plan that comprises performing 60 minutes of cardiovascular exercise 3 times per week along with 20 minutes of weight training 3 times per week.

FIG. 17 is a view showing an example dashboard screen 410 that can be used for displaying lifestyle and health-related information gathered from a participant. The screen 410 may represent, for example, a graphical user interface screen that can be accessed by a participant or a participant's wellness coach at the completion of a training program using one or more of the computer interfaces 234, 236, 238, 240 of FIG. 9. As shown in FIG. 17, and in some embodiments, the dashboard screen 410 includes a lab section 412 for displaying the participant's lab parameters and associated goals, a lifestyle section 414 for displaying the participant's lifestyle parameters and associated goals, and a body section 416 for displaying the participant's body parameters and associated goals. The parameters and associated goals displayed within each of the sections 412, 414, 416 may represent, for example, those parameters and goals described herein with respect to FIGS. 12 and 13.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for evaluating the health, wellness, and fitness status of individuals eligible for participation within a health plan offered by an employer, the system comprising:
a health club network including at least one scheduling and data input station and at least one screening station;
a laboratory network configured for performing laboratory tests on lab samples acquired from the at least one screening station;
a physicians network comprising a network of medical personnel for analyzing health-related data acquired by the health club network and laboratory data acquired from laboratory tests performed by the laboratory network;
a computer database configured for storing the health-related data and laboratory data; and
a means for evaluating each individual's eligibility to enroll in the health plan.

2. The system of claim 1, wherein the at least one scheduling and data input station includes a computer interface configured for prompting each individual to complete a health risk assessment questionnaire.

3. The system of claim 1, wherein the at least one scheduling and data input station includes a computer interface configured for prompting each individual to schedule a health screening at one or more screening stations.

4. The system of claim 1, wherein the at least one screening station comprises one or more of a body analyzer, a sphygmomanometer, a blood test kit, and an exercise test apparatus.

5. The system of claim 1, wherein the means for evaluating each individual's eligibility to enroll in the health plan comprises a health analysis module configured for generating a health, wellness, and fitness profile for each individual.

6. The system of claim 5, wherein the health analysis module is configured for generating the health, wellness, and fitness profile for each individual based at least in part on the health-related data acquired by the health club network and the laboratory data acquired by the laboratory network.

7. The system of claim 6, wherein the health-related data comprises questionnaire data acquired from a health risk assessment questionnaire and health screening data acquired from the at least one screening station.

8. The system of claim 5, wherein the health analysis module is further configured for generating a health score for each individual based at least in part on the health-related data acquired by the health club network and the laboratory data acquired by the laboratory network.

11. The system of claim 1, wherein the means for evaluating each individual's eligibility to enroll in the health plan comprises a means for comparing the health-related data and laboratory data against eligibility criteria for the health benefits or insurance program.

12. A process for evaluating the health, wellness, and fitness status of an individual eligible for participation within a health plan offered by an employer, the process comprising:
obtaining an eligibility file containing a list of individuals eligible for participation within a health benefits or insurance program;
prompting an individual to create an on-line account and complete a health risk assessment questionnaire;
scheduling at least one screening session at a screening station for evaluating health-related data for the individual;
collecting at least one laboratory sample from the individual during the at least one screening session;
prompting a laboratory test be conducted on the laboratory sample;
prompting medical personnel to review laboratory results obtained from the laboratory test and the health-related data obtained from the individual;
generating a health, wellness, and fitness profile and health score for the individual based at least in part on the laboratory results and the health-related data; and
storing the profile and health score in a computer database.

13. The process of claim 12, wherein the health risk assessment questionnaire comprises questions relating to the individual's medical history, exercise choices and goals, nutrition choices and goals, lifestyle choices and goals, and emotional status.

14. The process of claim 12, wherein the at least one screening station comprises one or more of a body analyzer, a sphygmomanometer, a blood test kit, and an exercise test apparatus.

15. The process of claim 14, wherein the at least one screening session comprises one or more of conducting a blood pressure screening test, conducting a body composition screening test, conducting a blood screening test, and conducting a fitness screening test.

16. The process of claim 12, wherein generating the health score comprises subtracting offset values for a plurality of metric parameters from an initial score.

17. The process of claim 16, wherein the metric parameters are selected from the group of metrics comprising a blood pressure metric parameter, a body fat percentage metric parameter, an LDL/HDL ratio metric parameter, a nicotine metric parameter, a glucose metric parameter, and a triglycerides metric parameter.

18. The process of claim 16, wherein the offset values are weighted based on a value or range associated with each metric parameter.

19. The process of claim 16, wherein the initial score comprises 100, and the offset values are selected from the group of values comprising 0, −8, or −16 based on a value or range associated with each metric parameter.

20. The process of claim 16, wherein the offset values vary based on an age and gender of the individual.

21. The process of claim 12, further comprising outputting the profile and health score to the individual or employer.

22. The process of claim 21, wherein outputting the profile and health score to the individual or employer comprises displaying the health, wellness, and fitness profile and health score on a dashboard screen of a graphical user interface.

23. A process for approving an individual for participation within a health plan offered by an employer, the process comprising:
linking a health club network to a physicians network and a laboratory network, the health club network including a screening station configured for acquiring health-related data and laboratory samples from an individual;
transmitting an order request to the physicians network prompting medical personnel within the physicians network to review the health-related data acquired by the screening station;
prompting the physicians network to transmit a laboratory order request to the laboratory network for performing one or more laboratory tests on the laboratory samples acquired from the screening station;
prompting the medical personnel to review laboratory results obtained from the one or more laboratory tests and the health-related data;
determining whether the individual is eligible for enrollment in the health plan; and
storing the laboratory results and health-related data in a computer database.

24. The process of claim 23, wherein, in determining whether the individual is eligible for enrollment in the health plan, the laboratory results and health-related data are compared against eligibility criteria from the employer.
